(19) United States
(12) Patent Application Publication
(10) Pub. No.: US 2024/0403686 A1
(43) Pub. Date: Dec. 5, 2024

(54) Quantum State Measurement Device, Quantum State Generation Device, and Quantum Key Distribution System

(71) Applicant: Nippon Telegraph and Telephone Corporation, Tokyo (JP)

(72) Inventors: Takuya Ikuta, Musashino-shi, Tokyo (JP); Seiseki Akibue, Musashino-shi, Tokyo (JP); Yuya Yonezu, Musashino-shi, Tokyo (JP); Toshimori Honjo, Musashino-shi, Tokyo (JP); Hiroki Takesue, Musashino-shi, Tokyo (JP)

(21) Appl. No.: 18/697,855

(22) PCT Filed: Oct. 6, 2021
(86) PCT No.: PCT/JP2021/037067

§ 371 Date: Apr. 2, 2024

(51) Int. Cl. G06N 10/60

(52) U.S. Cl. CPC G06N 10/60

(57) ABSTRACT

Disclosed are a high-dimensional quantum state generation device and a state measurement device using the mutually unbiased bases utilizing a finite field. The mutually unbiased bases in a high-dimensional quantum state are realized by a calculation method utilizing the finite field. A device is disclosed that utilizes mutually unbiased bases in the time-bin quantum state of light, frequency-bin quantum state and other modes of light, as the high-dimensional quantum state utilizing the finite field. The generation device and the measurement device are realized by the phase modulator and units equivalent to the matrix transformation operation, respectively. The measurement device includes a phase modulation unit corresponding to a diagonal unitary transform to a computational basis which is the first unit on the front stage side, and a high-dimensional Hadamard transform measurement unit or a Fourier transform measurement unit which is the second unit.

### TECHNICAL FIELD

The present invention relates to generation, measurement and application for communication of high-dimensional quantum states.

### BACKGROUND ART

Quantum communication can realize communication having high confidentiality that is not realizable with conventional communication technology, and communication at a high transmission rate, using photons as a carrier of information. A quantum key distribution (QKD) is also realized, which shares an encryption key that cannot leak to a third party in principle, by utilizing the fact that measurement of the quantum state inevitably causes a change in the state.

In order to make quantum communication and quantum information processing more sophisticated, research on making the used quantum states higher-dimensional has been actively performed in recent years. Since a high-dimensional quantum state can take a plurality of states orthogonal to each other, it is possible to increase an amount of information that one particle can transmit. A time-bin quantum state of photons is a stable quantum state which is less susceptible to disturbance on fiber transmission, and is widely used in quantum communication because of small state deterioration during transmission. The time-bin quantum state has an advantage that it can be easily made high-dimensional simply by increasing the time slots constituting the quantum state.

### CITATION LIST

### Non Patent Literature

[NPL 1] N. Islam, et al., Provably secure and high-rate quantum key distribution with time-bin qudits, Sci. Adv., 11 e1701491 (2017)

[NPL 2] W. K. Wootters and B. D. Fields, Optimal state-determination by mutually unbiased measurements, Ann. of Phys., 191 363-381 (1989)

[NPL 3] M. Rambo, “Low-Loss, All-Optical, Quantum Switching For Interferometric Processing of Weak Signals”, 2016. (Ph. D thesis)

[NPL 4] L. Sheridan and V. Scarani, “Security proof for quantum key distribution using qudit systems” Phys. Rev. A 82, 030301 (2010)

[NPL 5] M. Mafu, et al., “Higher-dimensional orbital-angular-momentum-based quantum key distribution with mutually unbiased bases” Phys. Rev. A 88, 032305 (2013)

[NPL 6] R. T. Thew, A. Acin, H. Zbinden, and N. Gisin, “Bell-Type Test of Energy-Time Entangled Qutrits” Phys. Rev. Lett. 93, 010503 (2004)

[NPL 7] P. Imany, et al., “50-GHz-spaced comb of high-dimensional frequency-bin entangled photons from an on-chip silicon nitride microresonator” Opt. Express 26, 1825 (2018)

[NPL 8] M. Kues, et al., “On-chip generation of high-dimensional entangled quantum states and their coherent control” Nature 546, 622 (2017)

[NPL 9] M. Roelens, et al., “Applications of LCOS-based programmable optical processors,” Optical Fiber Communication Conference 2014, W4F.3 (2014)

### SUMMARY OF INVENTION

### Technical Problem

In quantum information processing techniques such as quantum key distribution using the time-bin quantum state and quantum state tomography for measuring quantum states in detail, it is necessary to use the mutually unbiased bases (MUBs) in addition to a computational basis. The computational basis is made up of a physical orthogonal state of light to be a reference, and the MUBs are bases that are non-orthogonal to the computational basis. As a method of implementing the MUB, a technique using the Fourier transformed basis is known. However, the Fourier transform basis requires phase modulation with very high resolution and high accuracy as the dimension d increases. A requirement for high phase resolution in the state of MUB by the Fourier transform basis has a problem that accuracy and efficiency of state measurement are decreased. In addition, since the measurement device of the quantum state requires a large number of interferometers and photon detectors, there is also a problem that the scale of the measurement device increases with an increase in dimension d.

### Solution to Problem

An embodiment of the present invention is a measurement device of a high-dimensional quantum state which performs projective measurements onto higher-dimensional quantum states which are defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1), in which d=2^{N} (N is a natural number of 2 or more), and the quantum state of the label n is expressed by the following equation:

$$\vert {ψ}_{n}^{( r 〉} 〉 = {\sum }_{m} {B}_{mn}^{( r )} \vert m 〉$$

wherein a probability amplitude Bₘₙ^{(r)} is decomposed into a diagonal unitary matrix and the Hadamard transform matrix, and the measurement device includes: a phase modulation unit which corresponds to the diagonal unitary matrix, and applies a phase modulation on each state of the computational basis for a received d-dimensional quantum state; and a measurement unit which corresponds to the Hadamard transform matrix and determines the label n of the d-dimensional quantum state.

Another embodiment of the present invention is a measurement device of a high-dimensional quantum state which performs projective measurements onto higher-dimensional quantum states which are defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1), in which p is an odd prime, d=p^{N} (N is a natural number), and the quantum state of the label n is expressed by the following equation,

$$\vert {ψ}_{n}^{( r 〉} 〉 = {\sum }_{m} {B}_{mn}^{( r )} \vert m 〉$$

wherein a probability amplitude Bₘₙ^{(r)} is decomposed into a diagonal unitary matrix and a tensor product of the Fourier transform matrix, and the measurement device includes: a phase modulation unit which corresponds to the diagonal unitary matrix, and applies a phase modulation on each state of the computational basis for a received d-dimensional quantum state; and a measurement unit which corresponds to the Fourier transform matrix and determines the label n of the d-dimensional quantum state.

A further embodiment of the present invention is a generation device of a high-dimensional quantum state which is defined by a computational basis {|m>|m∈{0, 1, . . . , d−1}} of a d-dimensional quantum state made up of states of orthogonal light, and mutually unbiased bases of label r (integer of 0 or more) that are non-orthogonal to the computational basis and define a quantum state of label n (0, 1, . . . , d−1),
in which d=2^{N} (N is a natural number of 2 or more), and the quantum state of the label n is represented by the following equation:

$$\vert {ψ}_{n}^{( r 〉} 〉 = {\sum }_{m} {B}_{mn}^{( r )} \vert m 〉$$

and wherein a basis element of a finite field of an order d is defined as fᵢ, and a symmetry matrix A^{(j)} is defined to satisfy the following equation:

$${f}_{i} ⊙ {f}_{j} = {\sum }_{k = 0}^{N - 1} {A}_{ij}^{( k )} {f}_{k}$$

the probability amplitude is expressed by

$${B}_{mn}^{( r )} = \frac{1}{\sqrt{{2}^{N}}} exp ( \frac{π}{2} i ( {\sum }_{j = 0}^{N - 1} {r}_{1} {m}^{T} {A}^{( j )} m + 2 m \cdot n ) ) ,$$

and takes only four phase states by the generation device.

A further embodiment of the present invention is a generation device of a high-dimensional quantum state which is defined by a computational basis {|m>|m∈{0, 1, . . . , d−1}} of a d-dimensional quantum state made up of states of orthogonal light, and mutually unbiased bases of label r (integer of 0 or more) that are non-orthogonal to the computational basis and define a quantum state of label n (0 1, . . . , d−1), in which d=p^{N} (N is a natural number, and p is an odd prime), and the quantum state of the label n is represented by the following equation:

$$\vert {ψ}_{n}^{( r )} 〉 = {\sum }_{m} {B}_{mn}^{( r )} \vert m 〉$$

wherein a basis element of a finite field of an order d is defined as fᵢ, and a symmetry matrix A^{(j)} is defined to satisfy the following equation:

$${f}_{i} ⊙ {f}_{j} = {\sum }_{k = 0}^{N - 1} {A}_{i j}^{( k )} {f}_{k}$$

the probability amplitude is expressed by

$${B}_{mn}^{( r )} = \frac{1}{\sqrt{{p}^{N}}} exp ( \frac{2 π}{p} i ( {\sum }_{j = 0}^{N - 1} {r}_{j} {m}^{T} {A}^{( j )} m + m \cdot n ) ) ,$$

and takes only p phase states by the generation device.

### Advantageous Effects of Invention

Provided is a simplified high-dimensional state generation/state measurement device that relaxes a request for phase resolution.

### BRIEF DESCRIPTION OF DRAWINGS

FIG. 1 is a conceptual diagram explaining a computational basis for a time-bin quantum state.

FIG. 2 is a conceptual diagram showing a simplified system for information transmission by quantum communication.

FIG. 3 is a diagram conceptually showing a relationship between MUBs and computational basis.

FIG. 4 is a diagram showing the configuration of an MUB state generation device using the finite field of the present disclosure.

FIG. 5 is a diagram showing another configuration of the MUB state generation device utilizing a finite field.

FIG. 6 is a diagram showing the configuration of the MUB state measurement device using the finite field of the present disclosure.

FIG. 7 is a diagram conceptually explaining a high-dimensional Hadamard transform operation on a quantum state.

FIG. 8 is a diagram for explaining the configuration of a tree-structured Hadamard transformed state measurement unit.

FIG. 9 is a diagram for explaining the relationship between the delay of each MZI and a measurement pulse at an output port.

FIG. 10 is a diagram for explaining the Hadamard transformed state measurement unit using delay lines.

FIG. 11 is a diagram for explaining the Hadamard transformed state measurement unit using optical SW.

FIG. 12 is a diagram for explaining the Hadamard transformed state measurement unit having a loop configuration.

FIG. 13 is a diagram showing a configuration example of a state measurement device for MUBs including a computational basis.

FIG. 14 is a diagram showing another configuration example of a state measurement device for MUBs utilizing a finite field.

FIG. 15 is a diagram for explaining MUB state generation of a two-dimensional time-bin qubit.

FIG. 16 is a diagram for explaining an MUB state generation device of an 8-dimensional time-bin qubit.

FIG. 17 is a diagram of a quantum key distribution system based on MUB quantum states using finite fields.

FIG. 18 is a diagram of another quantum key distribution system based on MUB quantum state using finite fields.

FIG. 19 is a diagram for explaining the configuration of a p-dimensional Fourier transformed state measurement unit.

FIG. 20 is a diagram for explaining a Fourier transformed state measurement unit using a delay line.

FIG. 21 is a diagram for explaining the configuration of a state generation device based on frequency-bin quantum states.

FIG. 22 is a diagram for explaining a high-dimensional Hadamard transform in the frequency-bin quantum state.

FIG. 23 is a diagram for explaining a MUB state measurement device in the frequency-bin quantum state.

FIG. 24 is a diagram for explaining the Hadamard transformed state measurement unit in the frequency-bin quantum states.

### DESCRIPTION OF EMBODIMENTS

In the following disclosure, a quantum state generation device and a quantum state measurement device based on mutually unbiased bases (MUB) utilizing a finite field is presented. Also, high-dimensional quantum key distribution using the quantum state generation device and the quantum state measurement device is presented. First, problems in the quantum state generation device and the quantum state measurement device of the related art using the Fourier transformed basis will be described. Next, features and various implementation forms of the quantum state generation device and the quantum state measurement device using the MUBs utilizing the finite field of the present disclosure will be described. Further, a quantum key distribution system using the quantum state generation device and the quantum state measurement device will be described. For the sake of simplicity, in the following description, when simply referred to as “generation device” and “measurement device”, it is assumed that the quantum state generation device and the quantum state measurement device are respectively referred to.

The high-dimensional MUBs are realized by a calculation method utilizing a finite field. In the following disclosure, the mutually unbiased bases in a time-bin quantum state of light using an orthogonal mode of time as the computational basis will be described as an example as a high-dimensional quantum state utilizing a finite field. As will be described later, the generation device and the measurement device of the present disclosure can be realized by a phase modulator unit and a unit equivalent to a matrix transformation operation, respectively. In this respect, the disclosure of the time-bin quantum state described below can be similarly applied to each device in a high-dimensional quantum state by other modes of light. An example of the measurement device and the generation device utilizing other modes of light other than the time-bin quantum state using the orthogonal mode of time will be described finally.

### Time-Bin Quantum State, Mutually Unbiased Bases (MUB)

As described above, the time-bin quantum state is a stable quantum state which is less susceptible to disturbance on fiber transmission. First, the computational basis will be described to explain the MUBs for the time-bin quantum state.

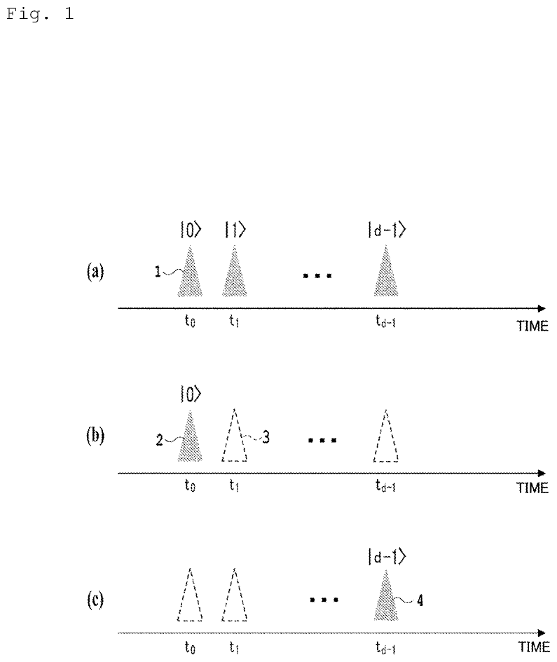

FIG. 1 is a conceptual diagram for explaining the computational basis in the time-bin quantum state. As shown in FIG. 1(a), several temporal positions (d positions: t₀, t₂, . . . , t_{d-}1) of successive optical pulses 1 on the time axis is considered. A state in which a single photon exists at any one of these temporal positions is considered. FIG. 1(b) shows a state in which a single photon exists only in the optical pulse 2 of the temporal position t₀. No optical pulse exists at other temporal positions except to as shown by a triangle 3 with a dotted line. Similarly, FIG. 1(c) shows a state in which a single photon exists only in the optical pulse 4 of the temporal position t_{d-}1. As shown in FIG. 1(b), FIG. 1(c), |i>(|0>, |1>, . . . , |d−1>) is a state in which photons exist only at the time tᵢ, that is, a state of the computational basis of the dimension d.

In the quantum key distribution, it is necessary to generate not only the state of the computational basis in which photons exist definitely at a specific time as shown in FIG. 1, but also the state of the MUBs which is non-orthogonal to the state of the computational basis and is in a superposed state (generation device), or to perform projective measurement on the state of the MUB (measurement device).

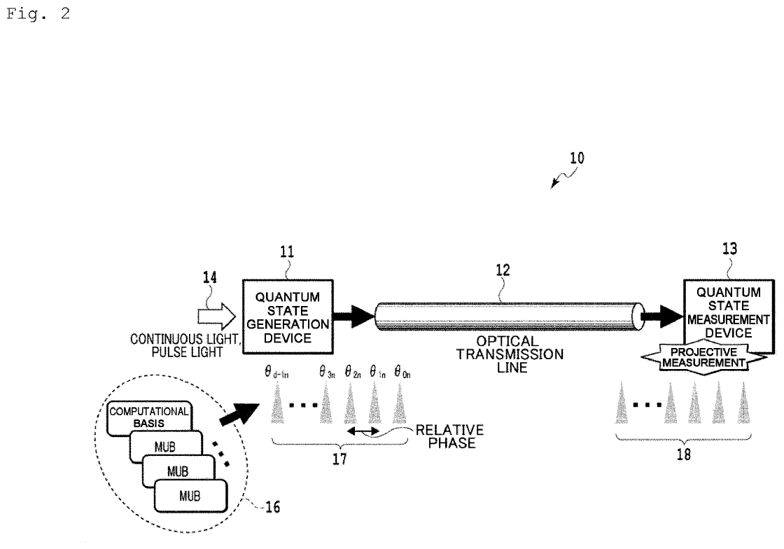

FIG. 2 is a conceptual diagram showing a simplified system of information transmission by quantum communication. The quantum communication system 10 includes a generation device 11, an optical transmission path 12 for transmitting the quantum state, and a measurement device 13. In the generation device 10, continuous light or pulse light 14 is input, and intensity and phase modulation are applied to the optical pulse train 17 based on the computational basis and the MUBs 16 to generate a necessary quantum state. In the measurement device 13, for example, projective measurement is performed on the received optical pulse train 18 to measure the quantum state.

The MUBs are basic constituent elements that appear in the above-mentioned quantum communication, quantum key distribution, quantum state tomography, which is a technique for measuring a state density operator, and various scenes of other quantum information processing. In recent years, in order to improve a secret key generation rate in the quantum key distribution, a method of utilizing MUBs in high-dimensional quantum state has been reported.

### MUB Based on the Fourier Transformed Basis

The MUB for the computational basis is a basis in which all basis states are non-orthogonal to the basis state in the computational basis, and defined as an superposed state of the basis states of the computational basis, and refers to an orthonormal basis in which a square of an absolute value of an inner product between two states of an arbitrary basis state included in the MUB and an arbitrary basis state of the computational basis is 1/d with respect to the dimension d. According to another definition, the MUBs are two orthonormal bases, where a basis state in one basis is a non-orthogonal quantum state which is the superposed state of all basis states contained in the other basis, and refers to two bases in which the absolute square of the inner product between the two quantum states is 1/d for the dimension d in any combination that extracts one basis state from each of the two bases.

As a method of implementing MUB required for high-dimensional quantum key distribution, the Fourier transformed basis |fₙ> expressed by the following equation has been mainly used.

$$\{ \vert {f}_{n} 〉 \vert n ∈ [ 0 , d - 1 ] , \vert {f}_{n} 〉 = \frac{1}{\sqrt{d}} {\sum }_{m = 0}^{d - 1} {e}^{\frac{\text{?}}{d}} \vert m 〉 \} \qquad Equation ( 1 )$$

$$\text{?} \text{indicates text missing or illegible when filed}$$

In the above equation, m is a label (integer) defining the state of the computational basis, n is a label (integer) indicating the state of the Fourier transformed basis, and d is the dimension of the computational basis and the Fourier transformed basis.

The Fourier transformed basis |fₙ> has a phase proportional to 1/d with respect to the dimension d, as is apparent from the term “e” in equation (1). For this reason, a phase modulation with very high resolution is required as the dimension d increases to generate the state of the MUB based on the Fourier transformed basis of equation (1). In the time-bin quantum state based on the Fourier transformed basis, which is also disclosed in the NPL 1, high phase resolution is required, and the accuracy and efficiency of the state measurement are reduced. Even in the implementation of the measurement device, d−1 interferometers and d photon detectors are required, and the scale of the measurement device increases with an increase in dimension d.

In order to solve the above-mentioned problem that high phase resolution is required with the increase in the dimension d, another MUB utilizing a finite field is introduced into a device for handling a high-dimensional quantum state. By utilizing the MUB utilizing the finite field, the required conditions of the phase resolution are greatly relaxed, the device configuration is simplified, and the generation device and the measurement device can be mounted in a scalable manner.

### MUB Based on Finite Field

It is considered that the finite field has the order d=2^{N}, and when the element of the finite field is expressed in a bit string, addition becomes an exclusive or of each constituent element (condition 1). Further, the element of a finite field in which only the i-th bit in the bit string expression is 1 is defined as fᵢ, and a symmetric matrix A^{(j)} satisfying the following equation is defined (condition 2). The operator on the left side of the following equation represents a binary operation of a product on the finite field.

$${f}_{i} ⊙ {f}_{j} = {\sum }_{k = 0}^{N - 1} {A}_{i j}^{( k )} {f}_{k} \qquad Equation ( 2 )$$

When the above-mentioned conditions 1 and 2 are satisfied and the dimension is d=2^{N}, a basis defined by the following equation is considered.

$$\{ \vert {ψ}_{n}^{( r )} 〉 = {\sum }_{m} {B}_{mn}^{( r )} \vert m 〉 \} \qquad Equation ( 3 )$$

$${B}_{mn}^{( r )} = \frac{1}{\sqrt{{2}^{N}}} exp ( \frac{π}{2} i ( {\sum }_{j = 0}^{N - 1} {r}_{j} {m}^{T} {A}^{( j )} m + 2 m \cdot n ) ) , n ∈ \{ 0 , 1 , … , d - 1 \} \qquad Equation ( 4 )$$

The above equation (3) is a basis utilizing a finite field, and shows the mutually unbiased bases (MUBs) as described later, and equation (4) shows a probability amplitude of this basis. The computational basis |m> is expressed by the following equation.

$$\{ \vert m 〉 \vert m ∈ \{ 0 , 1 , … , d - 1 \} \} \qquad Equation ( 5 )$$

Further, m,n, and r are defined as follows:
m: A label that defines the state of the computational basis
n: A label that defines the state of mutually unbiased bases (MUBs)
r: A label of the MUBs

In parentheses including the Σ of equation (4), r, m, and n (bold character) represents a vector when r, m, and n are each expressed as bit strings. Further, rⱼ (bold character) is a scalar amount indicating the j-th bit when r is expressed in a bit string. m^{T} (bold character) is a horizontal vector, A^{(j)} is a square matrix, and m (bold character) is a vertical vector.

The bases defined by the above equations (2) to (4) are mutually unbiased against the computational basis |m>. Also, they are also mutually unbiased between different r bases. That is, the bases defined by the formulae (2) to (4) form mutually unbiased bases (NPL 2). Also, (d+1) sets of new bases obtained by simultaneously taking complex conjugation to all the probability amplitudes of the state of the MUB generated in this way are also formed as (d+1) pieces of MUB. For this reason, the same discussion is established for the method based on equations obtained by taking the complex conjugation of equations (3) to (4) in the following description.

In the above definition, the element of a finite field in which only the i-th bit is 1 in the bit string expression is defined as fᵢ. In the configuration method of the finite field itself, there are a plurality of other methods, and the finite field having the same order number can be indicated to be equivalent to a single finite field by rearranging the labels representing the elements. Therefore, it is immediately understood that there are a plurality of states having exactly the same probability amplitude as equation (4) by the rearrangement of the labels. In addition, it is clear that MUBs obtained by simply and independently rearranging m, n, and r have the same values when they are associated with each other by inverse transformation for rearranging them again. Even with the MUBs having the same value by the rearrangement of the labels, the example of the MUBs described below are appropriate as they are, and the same discussion is established.

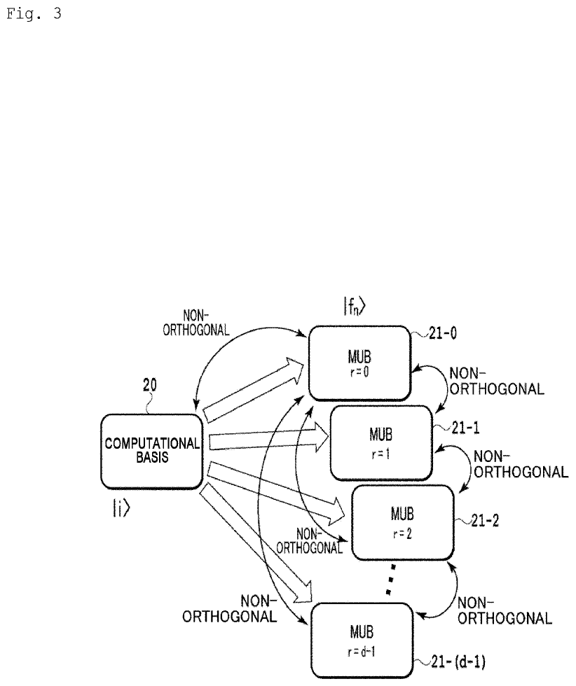

FIG. 3 is a diagram conceptually showing the relationship between the MUB and the computational basis. The d MUBs 21-0 to 21-(d−1) are generated from the computational basis 20. All bases of FIG. 3 are non-orthogonal to each other. For example, the MUB 21-0 (label r=0) is non-orthogonal to the other (d−1) MUBs, and the MUB 21-0 is non-orthogonal to the computational basis 20. In FIG. 3, the non-orthogonal display is shown only for the MUB 21-0 to make the drawings casy to see, but the relationship between the MUB 21-0 and the other MUBs is established for all the other MUBs.

In the MUBs defined by equations (2) to (4), at most four kinds of phases of each probability amplitude appear at an arbitrary dimension d=2^{N}. This is easily understood from the fact that the parentheses including Σ of the term E in equation (4) are always an integer, and the phase that the probability amplitude can take is an integer multiple of π/2. Therefore, the MUBs defined by equations (2) to (4) can avoid the problem that a higher phase resolution is required with an increase in the dimension d in the Fourier transformed basis according to equation (1).

In the MUB defined by equations (2) to (4), at most (d+1) bases which are mutually unbiased can be generated. That is, in equation (4), the label of MUB is r=0, 1, . . . and d−1, d of MUB are generated by equation (3), and one computational basis {Im>} is added thereto, and all (d+1) bases are bases which are mutually unbiased to each other.

In the following description, the configuration of the quantum state generation device and the measurement device using MUBs defined by the above-mentioned equations (2) to (4) is disclosed.

### State Generation Device of MUB Using Finite Field

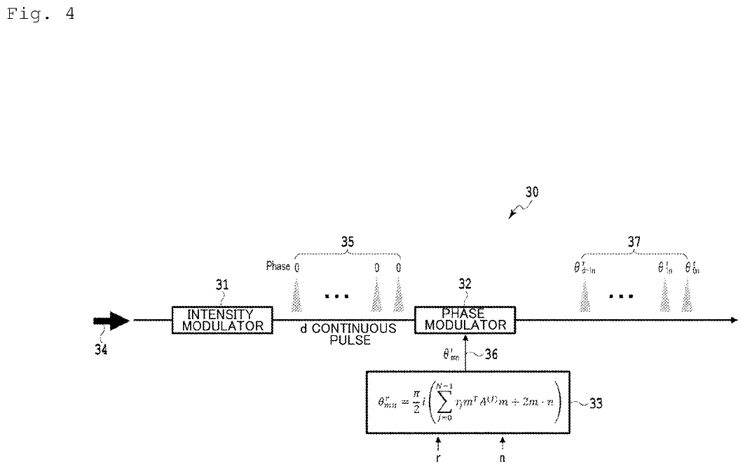

FIG. 4 is a diagram showing a configuration of a MUB state generation device using the finite field of the present disclosure. The generation device 30 is configured to generate the states of the MUBs based on equations (3) and (4), and to generate the states of the computational basis. An intensity modulator 31 and a phase modulator 32 are connected in cascade. A modulation signal generator 33 for supplying a modulation signal 36 to the phase modulator 32 is also provided. The intensity modulator 31 receives continuous light or continuous pulse light 34, and outputs d continuous pulses 35 when the states of the MUBs are generated. The continuous pulses 35 have not yet been phase-modulated, and a relative phases between the pulses are 0 at any time.

The modulation signal generator 33 generates a modulation signal (control signal) 36 for applying phase modulation according to the probability amplitude of equation (4) with respect to each pulse of the continuous pulses 35, based on the information r of the basis and the information of the label n of the state in the basis. The phase modulation is applied to each pulse of the continuous pulse 35 input to the phase modulator 32 by the modulation signal 36, and an output pulse train 37 is obtained.

The intensity modulator 31 is also used to generate a computational basis |m> expressed by equation (5). That is, the intensity modulator 31 operates to transmit only the m-th pulse of the d pulses to the phase modulator 32 instead of the d continuous pulses 35 for generating the states of the MUBs, and to suppress the other pulses. The input light 34 to the intensity modulator 31 may be continuous light or pulse light repeatedly generated at predetermined intervals. By the generation device having the configuration of FIG. 4, it is possible to generate the high-dimensional quantum states of the MUBs that utilizes the finite field having only four relative phases using the leading pulse of the d continuous pulses as the reference.

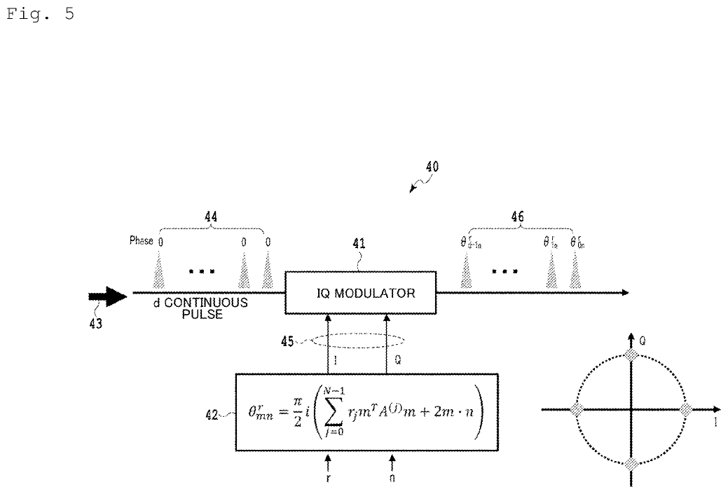

FIG. 5 is a diagram showing another configuration of the state generation device using the MUBs that utilizes the finite field of the present disclosure. Similarly to the generation device 30 of FIG. 4, a generation device 40 is also configured to generate the states of the MUBs based on equations (3) and (4) and also generate the states of the computational basis. The generation device 40 includes an optical IQ modulator 41 and a modulation signal generator 42. The modulation signal generator 42 gencrates two modulation signals (I signals, and Q signal) 45 for applying the phase modulation according to equation (4) with respect to each pulse of the continuous pulses 44, based on the information r of the basis and the information of a label n of a state in the basis. The optical IQ modulator 41 applies the phase modulation to each pulse of the continuous pulses 44 by the I signal and the Q signal 45 to obtain an output pulse train 46.

If the optical IQ modulator 41 is used as in the configuration of FIG. 5, the same operation as that of the generation device shown in FIG. 4 can be performed only by a single modulator. Since the optical IQ modulator can be compactly mounted as a single modulator, the configuration of the generation device can be further simplified. Although FIG. 5 shows an example of the d continuous pulses as the input light 43, any state of the computational basis and the MUB can be generated, even when the continuous light is input.

FIGS. 4 and 5 directly generate the states of the MUBs defined by equations (2) to (4) and the computational basis according to equation (5). In addition to such a generation device, a configuration in which the configuration of the measurement device is inverted is also considered. These other configurations are touched again after the configuration and operation of the measurement device in the next section are described in detail.

### State Measurement Device of MUB Using Finite Field

The configuration and operation of the state measurement device using the MUBs utilizing the finite field will be described below. In the following disclosure, the state measurement of the MUBs expressed by equations (2) to (5) will be explained by taking the time-bin quantum state as an example. However, in the point that the measurement device is realized by dividing it into two units, the following disclosure can be applied not only to a time-bin quantum state which is an orthogonal mode in time, but also to quantum states of other optical modes. As will be described later, the MUB measurement device using the finite field of the present disclosure includes a first unit corresponding to a diagonal unitary transform for the computational basis, and a second unit corresponding to the Hadamard transformed state measurement for performing projective measurements by decomposing into a lower-dimensional quantum state equivalent to a received high-dimensional quantum state. Such a configuration for decomposing the probability amplitude of the MUB into partial systems of two matrices can also be applied to state measurement in a case where other optical modes are used as a computational basis, such as frequency modes orthogonal to each other in terms of frequency, spatial modes utilizing the orbital angular momentum of light, optical path, and the like.

A basic principle and a specific example of the configuration of the measurement device using the MUB utilizing the finite field will be described below by taking the time-bin quantum state as an example.

### Basic Configuration of Measurement Device by Two Units

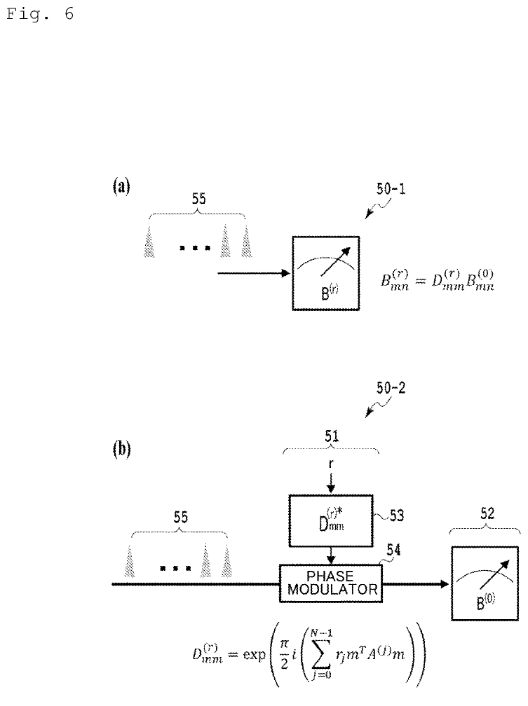

FIG. 6 is a diagram explaining a basic configuration of MUB state measurement device using the finite field of the present disclosure. FIG. 6(a) shows the most conceptual measurement device. The quantum state measurement device can be understood as a measurement device 50-1 for identifying the label n of the quantum state |Ψₙ^{(r)}> having the probability amplitude Bₘₙ^{(r)} expressed by equation (4), for example, with respect to the input pulse train 55 to be an object in the time-bin quantum state.

Equation (4) representing the probability amplitude Bₘₙ^{(r)} of the MUBs using the finite field can be decomposed into two matrices as follows.

$${B}_{mn}^{( r )} = {D}_{mm}^{( r )} {B}_{mn}^{( 0 )} \qquad Equation ( 6 )$$

$${D}_{mm}^{( r )} = exp ( \frac{π}{2} i ( {\sum }_{j = 0}^{N - 1} {r}_{j} {m}^{T} {A}^{( j )} m ) ) \qquad Equation ( 7 )$$

In equation (6), the left term Dₘₘ^{(r)} on the right side of the equation is a diagonal unitary matrix. Referring to equation (7), it can be seen that the Dₘₘ^{(r)} consists of only the exp term, and the Dₘₘ^{(r)} corresponds to the phase modulation to each pulse in the case of the time-bin quantum state. Therefore, a unit corresponding to the diagonal unitary matrix, the left term on the right side of equation (6), can be realized as a phase modulator for the computational basis.

Referring to both sides of equation (6), the relationship defined by equation (6) represents a transformation between different bases, that is, a transformation between bases from a MUB having a specific label r=0 to a MUB having an arbitrary label r. Therefore, if a measurement unit corresponding to the right term Bₘₙ⁽⁰⁾ on the right side of equation (6) can be realized, it is possible to realize the state measurement of an arbitrary label r in the MUB by combining it with a unit corresponding to a diagonal unitary matrix. The operation by the right term Bₘₙ⁽⁰⁾ on the right side of equation (6) corresponds to projective measurements on the Hadamard transformed basis, as will be described later. Therefore, the state measurement device can be configured to have a unit for performing phase modulation according to equation (7), on the front stage side of a measurement unit for manipulating the Hadamard transform matrix. Measurement to a basis (MUB of label r) having the probability amplitude Bₘₙ^{(r)} of equation (4) can be realized by means of a unit corresponding to two matrices decomposed from the probability amplitude Bₘₙ^{(r)} of the MUB.

FIG. 6(b) shows a measurement device 50-2 having a combined configuration of the above-mentioned two units. The measurement device 50-2 includes a phase modulation unit 51 corresponding to Dₘᵤ(r) which is a first unit on the front stage side, and a measurement unit 52 corresponding to Bₘₙ⁽⁰⁾ which is a second unit. A modulation signal generator 53 supplies a modulation signal to the phase modulator 54. However, in the phase modulation unit 51, the transformation from the r-th base to the 0-th base is required, instead of the transformation from the 0-th base (label 0) to the r-th base (label r). Equation (6) is obtained by decomposing the probability amplitude Bₘₙ^{(r)} in the generation of the MUB. Therefore, in the measurement device, the inverse transformation of the transformation expressed by equation (6), that is, the phase modulation which becomes the complex conjugate of the left term Dₘₘ^{(r)} on the right side of equation (6), is performed. In principle, the phase modulator 54 shown in FIG. 6(b) can be replaced by an optical IQ modulator as shown in FIG. 5.

A specific implementation method of the measurement unit 52 corresponding to Bₘₙ⁽⁰⁾ as the second unit following the phase modulation unit 51 as the first unit of the measurement device is a key for realizing the measurement device. Next, the principle of Hadamard transform for Bₘₙ⁽⁰⁾ and a specific implementation example will be described in detail with reference to the drawings.

### High-Dimensional Hadamard Transform

The measurement corresponding to the matrix Bₘₙ⁽⁰⁾ as the second unit shown in FIG. 6(b) can be implemented as a projective measurement to a state in which the state of a measurement object is decomposed into equivalent lower-dimensional two-dimensional quantum states (qubits) and two-dimensional Hadamard transform is performed on each of these states. Although physical particles do not correspond to each of the two-dimensional quantum states obtained by the decomposition, since the two-dimensional quantum states can be handled as virtual equivalent particles in terms of equations, they will be referred to as “particles” simply hereinafter, and when the two-dimensional quantum states can be decomposed into N states, they will be referred to as “N-particles”. Hereinafter, first, the high-dimensional Hadamard transform will be explained.

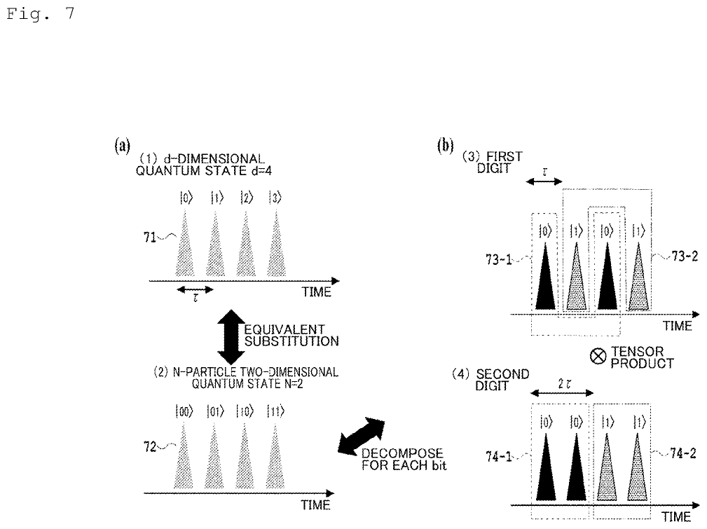

FIG. 7 is a diagram conceptually explaining a high-order Hadamard transform operation for a quantum state utilizing a finite field. FIG. 7(a) explains the replacement from the d-dimensional quantum state to an equivalent multi-particle state. The dimension d=4, that is, the four-dimensional quantum state 71 is considered. Each position of the pulse train disposed at the time interval τ corresponds to four quantum states of the computational basis, and the states |0>, |1>, |2>, |3> of the computational basis. Here, this four-dimensional quantum state is considered as an N-particle two-dimensional quantum state having an equivalent dimension. That is, the four quantum states 71 are considered by being replaced by four quantum states 72 of |00>, |01>, |10>, and |11> as a bit string expression of 2 bits (N=2).

FIG. 7(b) explains an operation of decomposing the N-particle two-dimensional quantum state for each bit as the next stage. When the four quantum states 72 which are two-particle two-dimensional states are decomposed into two states for each digit by paying attention to the bits of each digit, they are divided into two blocks having different delay times. When attention is paid to the first digit of the quantum state 72b, it is divided into a block 73-1 of a state |0> and a block 73-2 of a state |1>, and a time difference between the two blocks is τ. When attention is paid to the second digit of the quantum state 72b, it is divided into a block 74-1 of the state |0> and a block 74-2 of the state |1>, and the time difference between the two blocks is 2τ. The transformation of Bₘₙ⁽⁰⁾ of the second unit of FIG. 6 is an operation of performing the two-dimensional Hadamard transform on a bit-by-bit decomposition of the N-particle two-dimensional quantum state equivalent to the quantum state of a measurement object shown in FIG. 7(b), that is, all of the equivalent qubits.

The Hadamard transform H in the case of two-dimensional state is defined by the following matrix.

$$H = \frac{1}{\sqrt{2}} ( \begin{matrix}1 & 1 \\ 1 & - 1\end{matrix} ) \qquad Equation ( 8 )$$

If equation (8) is regarded as the probability amplitude Bₘₙ^{(r)} of equation (3) indicating MUB, the necessary projective measurements of the two-dimensional case are the following two states |+> and |−>.

$$\vert + 〉 = \frac{1}{\sqrt{2}} ( \vert 0 〉 + \vert 1 〉 ) \qquad Equation ( 9 )$$

$$\vert - 〉 = \frac{1}{\sqrt{2}} ( \vert 0 〉 - \vert 1 〉 ) \qquad Equation ( 10 )$$

In the case of high-dimensional Hadamard transform, the basis state of equation (3) showing the MUBs is expressed by the tensor product of two states |+> and |−> as shown in the following equation.

$$\vert + , + 〉 = \frac{1}{2} ( \vert 0 〉 + \vert 1 〉 ) ⊗ ( \vert 0 〉 + \vert 1 〉 ) = \frac{1}{2} ( \vert 0 , 0 〉 + \vert 0 , 1 〉 + \vert 1 , 0 〉 + \vert 1 , 1 〉 ) \qquad Equation ( 11 - 1 )$$

$$\vert - , + 〉 = \frac{1}{2} ( \vert 0 〉 - \vert 1 〉 ) ⊗ ( \vert 0 〉 + \vert 1 〉 ) = \frac{1}{2} ( \vert 0 , 0 〉 + \vert 0 , 1 〉 - \vert 1 , 0 〉 - \vert 1 , 1 〉 ) \qquad Equation ( 11 - 2 )$$

$$\vert + , - 〉 = \frac{1}{2} ( \vert 0 〉 + \vert 1 〉 ) ⊗ ( \vert 0 〉 - \vert 1 〉 ) = \frac{1}{2} ( \vert 0 , 0 〉 - \vert 0 , 1 〉 + \vert 1 , 0 〉 - \vert 1 , 1 〉 ) \qquad Equation ( 11 - 3 )$$

$$\vert - , - 〉 = \frac{1}{2} ( \vert 0 〉 - \vert 1 〉 ) ⊗ ( \vert 0 〉 - \vert 1 〉 ) = \frac{1}{2} ( \vert 0 , 0 〉 - \vert 0 , 1 〉 - \vert 1 , 0 〉 + \vert 1 , 1 〉 ) \qquad Equation ( 11 - 4 )$$

Configuration examples of several implementations of projective measurement device onto the high-dimensional Hadamard transformed basis which realize the transformation of Bₘₙ⁽⁰⁾ of the second unit shown in FIG. 6(b) will be explained, on the basis of the relationships from equations (9) to (11-4). In the following description, the projective measurement device to the high-dimensional Hadamard transformed basis, which realizes the transformation of Bₘₙ⁽⁰⁾ as the second unit shown in FIG. 6(b), is referred to as a Hadamard transformed state measurement unit or simply as a Hadamard transform unit.

### Implementation of High-Dimensional Hadamard Transform: Configuration Example 1

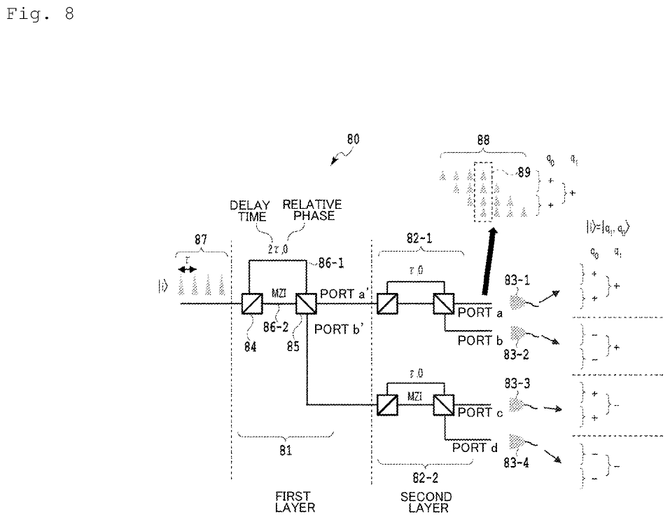

FIG. 8 is a diagram for explaining the configuration of the Hadamard transformed state measurement unit with a tree structure. A Hadamard transform unit 80 is made up of an interferometer of a two-layer configuration and four photodetectors 83-1 to 83-4. Specifically, a Mach-Zehnder interferometer (MZI) is used as the interferometer of each layer, and different delay times are set in the MZI for each layer. The MZI includes an input coupler 84, two arm waveguides 86-1 and 86-2 having different lengths, and an output coupler 85. In the MZI 81 of the first layer, a delay time difference between the long arm waveguide 86-1 and the short arm waveguide 86-2 is set to 2τ, and a relative phase difference is set to 0. In the MZIs 82-1 and 82-2 of the second layer, a delay time difference between the long arm waveguide and the short arm waveguide is set to τ, and a relative phase difference is set to 0.

In all the following descriptions, 2τ and 0 are indicated in the portion corresponding to the interferometer including waveguides having different lengths, and the delay time difference between the arm waveguides is indicated on the left side of the comma, and the relative phase between the arm waveguides is indicated on the right side of the comma.

Four continuous pulse 87 with a time interval τ to be an object by the time-bin quantum state are input to the MZI 81 of the first layer of the Hadamard transform unit 80. In the MZI disposed in the two-layer tree structure of FIG. 8, the output ports of the MZIs in the second layer are defined as a port a, a port b, a port c, and a port d, and photons from each port are detected by corresponding photodetectors 83-1 to 83-4. From the above four ports, projective measurements of all the input pulses onto the superposed state are realized at a specific time 89 as will be described later. The detection of photons at a certain output port is a projective measurement to any one of two states|+> and |−> on equivalent qubits corresponding to the port. For example, the information indicating to which of the port a′ and port b′ of the interferometer 81 having the delay time 2τ of the first layer is output corresponds to the projective measurements onto a state of either |+> or |−> of an equivalent qubit with a delay time of 2τ in the second digit (q₁ of |q₁, q₀>) decomposed into two-particle two-dimensional states in FIG. 7(b). Further, the superposed state of all the input states will be described together with the delay operation to the output point by each MZI disposed in the tree structure.

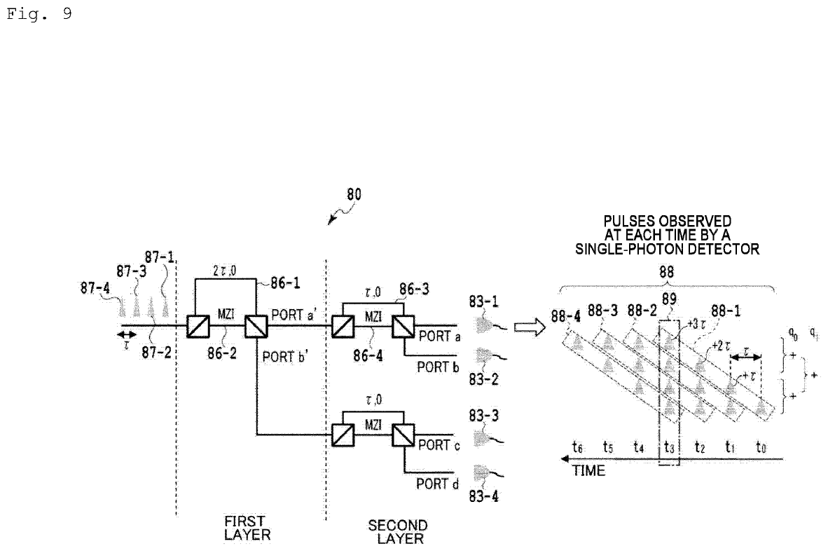

FIG. 9 is a diagram for explaining the relationship between the delay of each MZI and the measurement pulse at the output port. The Hadamard transform unit 80 shown in FIG. 9 is the same as that shown in FIG. 8. In FIG. 9, attention is paid to how the four-dimensional continuous pulse train 87 of a measurement object, which is input to the Hadamard transform unit 80, is output from each of the four output ports upon receiving the delay of the MZI of the two-layer configuration. The pulse train 87 is sequentially input to the MZI in the first layer from the pulse 87-1 arriving at the first time to the pulse 87-4 arriving at the last time. Here, a pulse 88 observed at each time at port a is considered. In the plurality of pulses 88 shown in FIG. 9, the four pulses disposed at the bottom along the time axis indicate pulses observed at each time through the path of the delay time 0. Similarly, the four pulses arranged along the time axis at the second time from the bottom indicate pulses observed at each time through the path of the delay time τ. Similarly, four pulses arranged along the time axis at the third and fourth positions from the bottom indicate pulses observed at each time through paths of delay times 2τ and 3τ, respectively.

When the first pulse 87-1 is input to the MZI of a multi-stage (multi-layer) configuration, it propagates through the shortest path of the short arms 86-2 and 86-4 of each MZI of two layers, and is observed as an output pulse 88-1 at a time t₀ after a fixed initial delay time. At the same port a, the second pulse 87-2 propagates through the shortest path and appears as an output pulse 88-2 at time t₁ after the delay time τ has elapsed from time t₀. At the same time, the first pulse 87-1 propagates through the long arm waveguide 86-3 of the second layer MZI, and appears as a pulse 88-1 (+τ) which is delayed by the time τ. In this way, at the time t₁, two pulses appear at the port a, and the two input pulses are in a superposed state.

At a time t₂ when a delay time 2τ elapses from the time t₀, a third pulse 87-3 propagates through the shortest path and appears as an output pulse 88-3. At the same time, the second pulse 87-2 propagates through the arm waveguide 86-3 of the second layer MZI and appears as a pulse 88-2 (+τ) which is delayed by the time τ, and the first pulse 87-1 propagates through the arm waveguide 86-1 of the first layer MZI and appears as a pulse 88-1 (+2τ) which is delayed by the time 21. In this way, at the time t₂, three pulses appear at the port a, and three input pulses are in a superposed state.

Further, at a time t₃ when a delay time 3τ elapses from the time to, the last pulse 87-4 propagates through the shortest path and appears as an output pulse 88-4. At the same time, the third pulse 87-2 propagates through the long arm waveguide 86-3 of the MZI of the second layer and appears as a pulse 88-3 (+τ) which is delayed by the time τ, the second pulse 87-2 propagates through the long arm waveguide 86-1 of the MZI of the first layer and appears as a pulse 88-2 (+2τ) which is delayed by the time 2τ, and the first pulse 87-1 propagates through the two layer MZI long arm waveguides 86-1 and 86-3 and appears as a pulse 88-1 (+3τ) which is delayed by a time of 3τ. At this time t₃, four pulses shown by a dotted line region 89 appear simultaneously at a port a, and the four input pulses are in the superposed state.

As described above, a plurality of pulses in the superposed state appears at the port a of the MZI of the second layer at each time, and the superposed state of all four input pulses 87-1 to 87-4 is obtained at a specific time t₃. In each MZI, the relative phase of the output light from the two output ports is set to 0. No phase change is given to the pulse output from the MZI regardless of the presence or absence of delay. Therefore, no phase fluctuation is given to four output pulses appearing at the output port an at the time t₃, and a state in which all the input continuous pulses 87 are superimposed with the same phase relationship is observed.

At the time t₃, the aforementioned superposed state of the four input pulses is observed similarly at the port b, the port c and the port d. In the photon detector, as a result of the delay by the MZI disposed in the two-layer configuration, projective measurement of all input states to the superposed state is realized in the dotted line region 89. Interference light passing through the MZI which is an interferometer is superimposed in a phase relation determined by the MZI optical path, and probability amplitudes of photons at different times on the input side are superimposed according to the interference pattern. Considering the phase at the time of interference in the MZI, it can be seen which state of two states |+> and |−> on equivalent qubits is measured depending on which output port of each of MZI, photon is observed.

In each output coupler in the MZI shown in FIG. 8, an interference state in which the relative phase is 0 (in-phase) is obtained at port a, port a′, and port c. On the other hand, at port b, port b′ and port d, interference states in which the relative phase is π (opposite phase) are obtained. Therefore, it can be understood that the interfered state and the interference pattern are different depending on which output port of the output coupler of the MZI is output. It should also be noted that if the input port is replaced in the input of the interferometer, the relationship between the same phase and the opposite phase is reversed.

Referring again to FIG. 8, information indicating to which of port a′ and port b′ of MZI 81 of delay time 2τ photons are output corresponds to whether the state measurement of the second digit of equivalent qubits |+>or |−> of FIG. 7 is performed. Therefore, at a time t₃, it is possible to determine which state of the projective measurement is performed by which port the photon is detected by the photon detector. In the case of a tree structure of two layer interferometers for the four-dimensional quantum state shown in FIG. 8, the relationship between photon detection and the measured state is as follows.
The photon detection in photodetector 83-1->|+,+>state of equation (11-1)
The photon detection in photodetector 83-2->|+,−>state of equation (11-2)
The photon detection in photodetector 83-3->|−,+>state of equation (11-3)
The photon detection in photodetector 83-4->|−,−>state of equation (11-4)

The configuration of the Hadamard transform unit by the interferometer disposed in a tree shape in FIG. 8 is realized by decomposing the high-dimensional time-bin quantum state of the measurement object into equivalent qubits, and setting a delay time in the interferometer of each layer in the tree structure equal to a delay time for specifying the equivalent qubits. Therefore, in the case of an 8-dimensional (d=2³=8) time-bin quantum state having 8 continuous pulses, an interferometer having a delay time of 4τ may be further added to the configuration of FIG. 8 as the 0-th layer, and the number of MZI in the first and second layers are doubled. As a result, the Hadamard transform unit for the 8-dimensional time-bin quantum state is made up of seven MZIs in three layers. Similarly, by adding MZIs (interferometers), a measurement device can be mounted for an arbitrary 2^{N}-dimensional time-bin quantum state.

In the configuration of the interferometer disposed in a tree shape in FIG. 8, the interferometer in one layer may have the same delay time. Therefore, even if the delay time is replaced between layers (for example, in the order of 2τ, 4τ, and τ) instead of decreasing the delay time in the order of the upper layer, the same state measurement can be performed. However, an interferometer having a longer delay time generally has problems of difficulty in manufacturing and stability. Therefore, the number of unstable interferometers decreases by setting the delay time in the descending order (in the order of 4τ, 2τ, and τ in the case of 8-dimensions), and a stable configuration is obtained as a whole of the measurement device.

Further, in the configuration of the tree-like Hadamard transform unit shown in FIG. 8, the relative phase of all interferometers can be set to 0. In order to measure the MUB using the Fourier transformed basis of the related art by the MZI configuration, it is necessary to incorporate a phase difference between the arm waveguides, for example, designed to be π/2, into a part of the tree-like configuration. The kind of the setting values for the phase value of the interferometer increases with the dimension d. If the phase difference can be set to 0, all interferometers can be adjusted only by adjusting certain amount of measurement, for example, the extinction ratio to the MZI to be maximum or minimum. Since the adjustment of the interferometers of each layer can be the same in phase difference 0 and can be simplified, there is an advantage that the adjustment of the interferometers is casy even when the dimension d becomes large.

### Implementation of High-Dimensional Hadamard Transform: Configuration Example 2

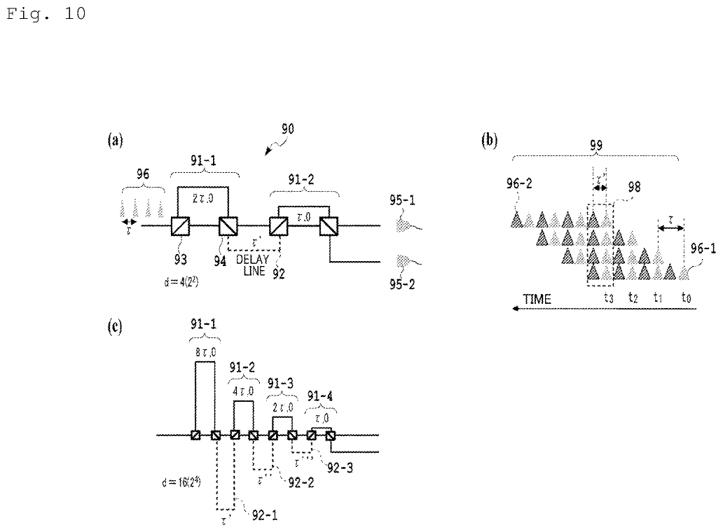

FIG. 10 is a diagram for explaining the configuration of a Hadamard transformed state measurement unit using a delay line. In the Hadamard transformed state measurement unit using the tree-like interferometer described in FIG. 8, a large number of interferometers are required as the dimension increases and the number of layers increases. However, the interferometers in the same layer have the same delay time and the same relative phase. Therefore, if one interferometer can be shared as an interferometer of the same layer by some methods, the number of interferometers can be reduced.

FIG. 10(a) shows a Hadamard transformed state measurement unit of configuration example 2 using a delay line. A Hadamard transform unit 90 of configuration example 2 receives the continuous pulse train 96 of the four-dimensional time-bin quantum state, similarly to the four-dimensional Hadamard transform unit shown in FIG. 8, but the overall configuration is significantly reduced. A first layer MZI 91-1 and a second layer MZI 91-2 are connected in cascade, and two output ports of the MZI 91-2 are provided with corresponding photon detectors 95-1 and 95-2. In the MZI 91-1 of the first layer, a delay time difference between the arm waveguides is set to 2τ and a relative phase is set to 0. In the MZI 91-2 of the second layer, a delay time difference between the arm waveguides is set to τ and a relative phase is set to 0. Therefore, the configuration of the MZI in each layer is the same as that of the MZI in the case of the tree-like arrangement shown in FIG. 8. The difference from the configuration of FIG. 8 is that a delay line 92 is connected between ports which are not used for cascade connection of two layers of MZI, that is, from another port of the output side coupler of the first layer of MZI to another port of the input side coupler of the second layer of MZI.

The delay line 92 is set to a delay time τ′ shorter than the delay τ of the second layer MZI. Therefore, a pulse passing through the delay line 92 from the other output port of the output coupler of the MZI 91-1 is input to the MZI 91-2 of the second layer with a delay time τ′, compared with a pulse passing through a path connected in cascade from one output of the MZI 91-1 of the first layer.

If the delay time τ′ of the delay line 92 is appropriately set, the function of two MZI disposed in parallel in the second layer of FIG. 8 can be achieved by utilizing one MZI 91-2 in a different time. In the configuration shown in FIG. 10(a), the delay time τ′ of the delay line 92 is set to a time shorter than the delay τ, but the inputs of different times to one interferometer 91-2 only need not to interfere with each other. If the delay time of the delay line is set to be shifted so that the inputs at different times do not interfere with each other, the delay time of the delay line may be set to an arbitrary value.

FIG. 10(b) shows the state of the output pulse 99 observed by the Hadamard transform unit 90 shown in FIG. 10(a). The output pulse 99 corresponds to the output pulse 88 in the tree-like configuration of FIG. 9, and the operation of the delay line 92 can be understood by comparing the two. In the output pulse 99 shown in FIG. 10(b), the triangular pulse 96-1 is a pulse that is output by two layers of MZI through a path directly connected to the cascade. Similarly to the case of the tree-like configuration example 1 of FIG. 8, observation is performed in the superposed state of four input continuous pulse 96 at the time t₃ in the dotted line region 98.

Four continuous pulse 96 delayed and input to the MZI 91-2 of the second layer via the delay line 92 correspond to the triangular pulse 96-2 of a dotted line of FIG. 10(b). It is similar to the output pulse of the path directly connected to the cascade, except that it is delayed by the delay time τ′ compared to pulse 96-1. Therefore, if, for example, τ′ is selected to be half of the time interval τ of the input pulse 96, output pulses disposed at τ/2 intervals can be obtained in any of the photon detectors. Four kinds of interference patterns are obtained by the combination of information on which of two output ports of the MZI of the second layer and two measurement times t₃ and t₃+τ′. These combinations can be associated with the four states of |+,+>, |−,+>, |+,−>, and |−,−>in the same manner as configuration example 1 of FIG. 8.

As described above, in the Hadamard transform unit 90 of configuration example 2 of FIG. 10, the single MZI of the second layer is repeatedly used with a time lag, and it can be recognized that the single MZI is reused a plurality of times in the time division system. The repeated use of such a single interferometer can be performed independently in each layer, except for the first layer, even if the number of layers increases. The number of necessary interferometers is greatly simplified to log d and the number of photon detectors is greatly simplified to two, by utilizing the interferometers a plurality of times (reuse).

FIG. 10(c) shows an example of the configuration of the Hadamard transform unit of configuration example 2 in the case of 16-dimension (d=2⁴). Four layers of MZIs 91-1 to 91-4 are cascade-connected. The delay time differences between the arm waveguides of the MZI of each layer are set to 8τ, 4τ, 2τ, and τ in order, and the phase difference between the arm waveguides is set to 0. The MZI of the first layer and the MZI of the second layer are connected in parallel with cascade connection by the delay line 92-1 of the delay time τ′. The MZI of the second layer and the MZI of the third layer are similarly connected in parallel by a delay line 92-2 of a delay time τ″. The MZI of the third layer and the MZI of the fourth layer are also connected in parallel by a delay line 92-3 of a delay time τ′″.

The delay time of each delay line may be set to a timing at which a plurality of pulses (solid line triangle and dotted line triangle) in the adjacent superposed state of FIG. 10(b) do not collide with each other at the output port.

When setting the τ′ of a delay line connecting interferometers of adjacent layers in parallel to each other so that photons delayed at an intermediate time between original detection times (t₀, t₁, t₂, . . . ) by the photodetector are detected as shown in FIG. 10(b), there is a case that the number of times that one interferometer can be repeatedly used in a time division system is limited. This is because a certain limit is generated to narrow the time interval of measurement due to the influence of timing jitter in a photon detector or an analyzer thereafter. In such a case, the interferometer can be partially repeatedly used for some layers in the whole Hadamard transform unit. In other words, a hybrid configuration may be adopted in which the tree-like configuration example 1 of FIG. 8 and configuration example 2 of FIG. 10 are combined and an interferometer using delay lines is repeatedly used in some layers.

For example, in the case of an 8-dimensional (d=2³), if it is realized by the tree-like configuration of configuration example 1, seven MZI and eight photon detectors are required in three layers. In the case where the hybrid configuration of configuration example 1 and configuration example 2 is adopted in the same 8-dimensional configuration, as the configuration for reusing the first layer and the second layer, a configuration using four photon detectors with only the third layer as a tree including two MZIs is conceivable. In the case of this hybrid configuration, projective measurements to eight states can be realized by the combination of two measurement timings and four photon detectors (2×4).

It should be noted that in each configuration shown in FIG. 10, the delay line functions only to cause delay, not to cause interference with input continuous pulses. Therefore, unlike the relative phase of the long arm waveguide in the interferometer of each layer, a change in the relative phase caused by the delay line can be ignored.

### Implementation of High-Dimensional Hadamard Transform: Configuration Example 3

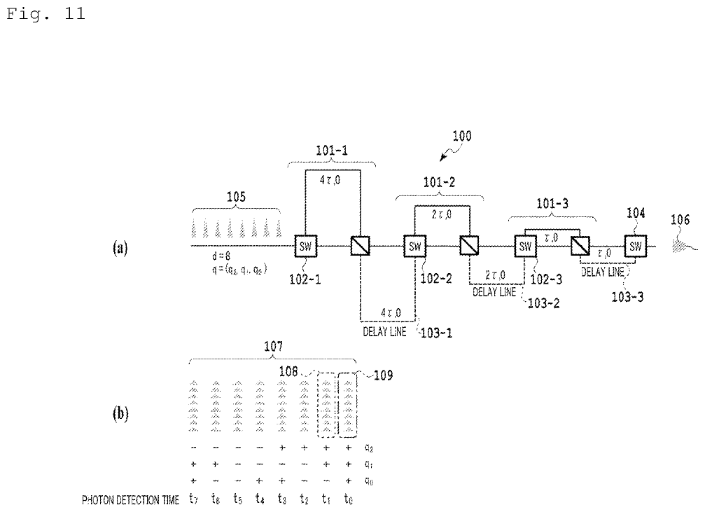

FIG. 11 is a diagram for explaining the configuration of a Hadamard transformed state measurement unit using an optical switch (optical SW). Compared to the Hadamard transformed state measurement unit 90 of FIG. 10, it is similar in that the interference structures including two arm waveguides are cascade-connected and the delay lines between the interference structures (interlayers) are connected in parallel. A Hadamard transform unit 100 of FIG. 11 has a configuration in which one layer is added to configuration example 2 of FIG. 10 in which adjacent MZIs of different layers are connected in parallel by a delay line to make the dimension d=8, and the input side coupler of the MZI as an interferometer is replaced by an optical SW.

Specifically, in the Hadamard transform unit 100 of configuration example 3 of FIG. 11, in configuration example 2 in which the dimension is set to d=8, the input couplers of the MZI units 101-1 to 101-3 of each layer are replaced by optical SW 102-1 to 102-3, and further, an optical SW104 is added to the final stage. When the input side coupler is replaced by the optical SW, the MZI units 101-1 to 101-3 of FIG. 11 are not strictly called a Mach-Zehnder interferometer (MZI). However, since two arm waveguides are included in which the delay time and the phase are set to predetermined values and which can cause interference, the optical waveguide is called an “MZI unit”.

Another difference between the Hadamard transform unit 100 and configuration example 2 of FIG. 11 is that the delay of delay lines 103-1 to 103-3 connected in parallel to a path for cascade-connecting the MZI units between the respective layers is set to the same value as the delay time of the respective pre-stage MZI units. Specifically, the delay time of the delay line 103-1 connecting the first layer and the second layer in parallel is set to 4τ which is the same as the delay time of the MZI unit 101-1 on the front stage side. The delay time of a delay line 103-2 connecting the second layer and the third layer in parallel is set to 2τ which is the same as the delay time of the MZI unit 101-2 on the front stage side. Similarly, the delay time of a delay line 103-3 connecting the third layer and the optical SW 104 in parallel is set to the t which is the same as the delay time of the MZI unit 101-3 on the front stage side. The photon detector 106 detects photons by the output of the optical SW 104 of the final stage.

In each layer, the optical SW replaced from the input coupler of the normal MZI operates to switch one or more inputs to one or more outputs. For example, the optical SW 102-1 outputs an input continuous pulse 105 to one of two arm waveguides of the MZI unit 101-1 in synchronization with the time interval τ. The optical SW 102-2 outputs pulses from two arm waveguides of the MZI unit 101-1 to either the MZI unit 101-2 or the delay line 103-1 of the next layer in synchronization with the time interval τ. Similarly, the optical SWs 102-3 and 104 also perform the switching operation of the relation between input and output in synchronization with the time interval τ. At this time, the optical SW operation is performed so that the output destination of the optical SW of each layer is determined in accordance with |0> and |1> of each qubit, when the high-dimensional quantum state is made to correspond to (associated with) an equivalent two-dimensional quantum state.

The delay time of the delay line in configuration example 3 is set to the same value as the delay time of each MZI unit on the preceding stage side, and the delay time is an integer multiple of the time interval τ of the input continuous pulse. Therefore, at the output point of the MZI unit of each layer, the pulses propagating through different paths appear simultaneously and are at a timing at which they can collide with each other. However, the collision is not caused by the switching operation of the input-output relation of each optical SW. As a result, at the output point of the optical SW 104 of the final stage, a superposed state by the different interference pattern of the input continuous pulse 105 interfered by the output coupler of each MZI unit is realized at the different time.

The Hadamard transform unit 100 in FIG. 11 switches the optical SW of each layer while synchronizing with the time interval τ of the input continuous pulse 105, and at the output point of the optical SW 104, at all measurement times (t₀ to t₇), the superposed state of the input continuous pulse 105 is realized. Since the first measurement time to is after all of the eight input continuous pulse 105 are input to the Hadamard transform unit 100, the time of at least 8τ elapses from the first pulse input. At any detection time (t₀, t₁, . . . , t₇), eight input pulses are in a superimposed and interfered state, and the interference pattern can be made to correspond to (associated with) high-dimensional Hadamard transform.

FIG. 11(b) shows pulses 107 observed at each time at the output point of the Hadamard transform unit 100 of configuration example 3. Eight pulses of the input continuous pulse 105 appear at the same time at any detection time from to to t₇. Therefore, when the 8-dimensional quantum state is represented as qubits of an equivalent three-particle two-dimensional quantum state, according to information indicating at which detection time the photon is detected, it is possible to determine to which state the projective measurement is performed in a combination of two-dimensional quantum states |+> and |−> on the equivalent qubit.
Photon detection at time t₀->1+,+,+> state
Photon detection at time t₁->|+,+,−> state
Photon detection at time t₂->|+,−,−> state
Photon detection at time t₃->|+,−,+> state
Photon detection at time t₄->|−,−,+> state
Photon detection at time t₅->|−,−,−> state
Photon detection at time t₆->|−,+,−> state
Photon detection at time t₇->|−,+,+> state

In the Hadamard transform unit 100 of FIG. 11, since the waveguide and the delay line connecting the MZI units of adjacent layers can be regarded as interference circuits, the delay time difference between the arm waveguides and the relative phase between the arm waveguides are shown as in the MZI shown in FIG. 8 and later.

The structural configuration of the Hadamard transform unit 100 of FIG. 11 is also disclosed in, for example, NPL 3. However, in order to measure the quantum state of the MUBs utilizing the finite field, the configuration is greatly different from that of the NPL 3 in that the relative phase of each delay line can be set separately and at an arbitrary value. In the configuration of FIG. 11, the relative phase generated by the delay of the delay lines 103-1 to 103-3 appears as the relative phase between the output pulses at different detection times, such as between the pulse in the dotted line 108 at the time ti and the pulse in the dotted line 109 at the time t₀ in FIG. 11(b). In other words, the relative phase generated by the delay line is not related to the phase between the pulses (between the eight pulses in the dotted line region 108) that appears as the superposed state of the input continuous pulse in the same detection time.

The phase of the delay line may be arbitrarily described as follows. In the Hadamard transform unit 100, photons are detected by a photon detector 106 immediately after a series of cascade-connected MZI units (interferometers). However, the measurement result of the photon detector 106 is not affected by the relative phase between the pulses (between the regions 108 and 109) in the superposed state corresponding to different detection times. Specifically, in FIG. 11(b), the relationship between the phase of the pulse in the region 109 at the time to and the phase of the pulse in the region 108 at the time ti does not affect the measurement result of the photon detector 106.

Therefore, the phases generated by the delay lines 103-1 to 103-3 can be arbitrarily set. In the Hadamard transform unit 100 of FIG. 11, the value of the phase difference may be varied between three delay lines, or may be an arbitrary value instead of 0.

In the Hadamard transform unit 100 shown in FIG. 11, the phase on the delay line can be arbitrarily set means that it is not necessary to stabilize the phase of these delay lines as in MZI units 101-1 to 101-3. In the MZI units 101-1 to 101-3, phase modulation should not be applied to each of the input continuous pulse. Therefore, the relative phase between the arm waveguides in the MZI units 101-1 to 101-3 should be set to 0 with high accuracy. On the other hand, with respect to the delay lines 103-1 to 103-3 of the Hadamard transform unit 100 of FIG. 11, the conditions of delay line design in an actual device can be greatly relaxed.

Further, in each of the Hadamard transform units of configuration example 1 of FIG. 8 and configuration example 2 of FIG. 10, only the measurement result of a part of the detection time at which all input pulses interfere with each other can be utilized in the output of the interferometer. Therefore, a decrease in the detection efficiency becomes a problem. On the other hand, in configuration example 3 of FIG. 11, the detection results of photons at all the detection times correspond to any projective measurement in the Hadamard transformed basis state. Therefore, it is possible to realize a state measurement device of the MUB utilizing the finite field, which does not deteriorate detection efficiency in principle. Further, in configuration example 3, the number of photon detectors can be reduced to one.

### Implementation of High-Dimensional Hadamard Transform: Configuration Example 4

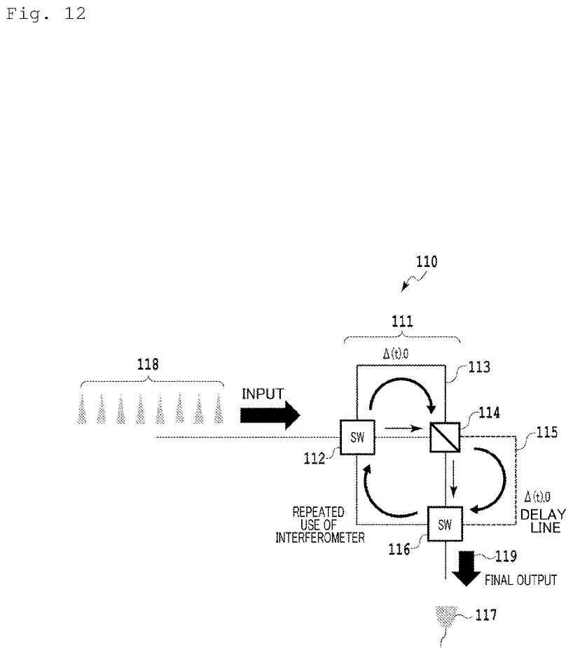

FIG. 12 is a diagram for explaining the configuration of a Hadamard transformed state measurement unit utilizing a loop-like configuration. A Hadamard transformed state measurement unit 110 shown of FIG. 12 of configuration example 4 changes the configuration of configuration example 3 into a loop shape and repeatedly uses the MZI unit as in configuration example 2, thereby realizing Hadamard transform with a further compact configuration.

In the Hadamard transformed state measurement unit 110, the MZI unit 111 includes an optical SW 112, two arm waveguides 113 having different lengths, and an output coupler 114, similarly to configuration example 3. One output port of the output coupler 114 is further connected to an input port of the optical SW 116. The other output port of the output coupler 114 is connected to another input port of the optical SW 116 via a delay line 115. One output of the optical SW 116 is input to the optical SW 112 to repeatedly use the MZI unit 111. The other output of the optical SW 116 is given to a photon detector 117 as a final output after the repeated use of the MZI unit 111 of a fixed number of times is finished. In this way, the MZI unit 111, the delay line 115 and the optical SW 116 are configured in a loop shape to be repeatedly used.

The delay time of the MZI unit 111 is set to Δ(t), and takes values such as τ, 2τ, 4τ, . . . like configuration example 3. The delay time Δ(t) changes with time in synchronization with the time interval τ of the input continuous pulse 118 so that the MZI unit 111 can be repeatedly used in different configurations. Similarly, the delay time of the delay line 115 is set to Δ(t), which is the same as that of the MZI unit 111, and changes with time in synchronization with the time interval τ of the input continuous pulse 118. By switching the relationship between the input and output in the two optical SWs 112, 116 in the same manner as in configuration example 3, the same MZI unit 111 is repeatedly used to enable the same operation as in configuration example 3. As the final output, in the case of an 8-dimensional output, cight input pulses are superimposed at all detection times, and an interfered state is obtained, as shown in FIG. 11(b). According to the information on the time when the photons are observed, it is possible to determine which state of the projective measurement is performed, when the 8-dimensional quantum state is decomposed into the 3-particle 2-dimensional quantum state.

From the above description, it can be understood that the configuration of the Hadamard transformed state measurement unit 110 of FIG. 12 is repeatedly used as different layers by forming the configuration of the MZI unit and the delay line for one layer linearly developed in FIG. 11 into a loop-like configuration by the feedback path. In the Hadamard transformed state measurement unit utilizing the loop-like configuration of FIG. 12, the same discussion as in configuration example 3 of FIG. 11 holds for the phase difference in the delay line 115. Therefore, the phase difference to be given to the delay line 115 may be an arbitrary value, and it is not necessary to stabilize the phase difference with respect to the optical path of the delay line. Furthermore, since the optical SW 116 and the optical SW 112 are fed back by the same waveguide and a single MZI unit is repeatedly used, there is no need to align phase values in the feedback path. Therefore, when the state measurement device of the MUB is configured using the Hadamard transform unit 110 of configuration example 4, only the accuracy of the phase difference between the two arm waveguides of the MZI unit 111 should be stabilized. By forming a feedback path in a single MZI unit to form a loop-like configuration, design and manufacturing conditions of the state measurement device can be greatly relaxed.

As described in the above four configuration examples, the Hadamard transformed state measurement unit in a time-bin quantum state can be implemented to include any one of a first configuration (configuration example 1) including a plurality of optical interferometers which are disposed in a tree shape with N layers, each of the plurality of optical interferometers having a delay time corresponding to the layer position of the N layers, a second configuration (configuration example 2, configuration example 3) including a plurality of optical interferometers cascade-connected to the N layers, each of the plurality of optical interferometers having a delay time corresponding to the layer position of the N layers, and one or more delay lines in which delay times are set corresponding to the delay times of the optical interferometers of the previous layer in parallel with the connection between two adjacent layers, or a third configuration (configuration example 4) including an optical interferometer which is connected in a loop, the optical interferometer having a variable delay time corresponding to the number of laps.

### State Measurement Device of MUB Using Finite Field: Specific Configuration 1

The configuration example 1 of FIG. 8, configuration example 2 of FIG. 10, configuration example 3 of FIG. 11, and configuration example 4 of FIG. 12 are examples of a Hadamard transformed state measurement unit that performs projective measurement to the Hadamard transformed basis, when the MUB state measurement device utilizing a finite field is decomposed into two units. Here, the specific overall configuration of the state measurement device including the state measurement of the computational basis is shown.

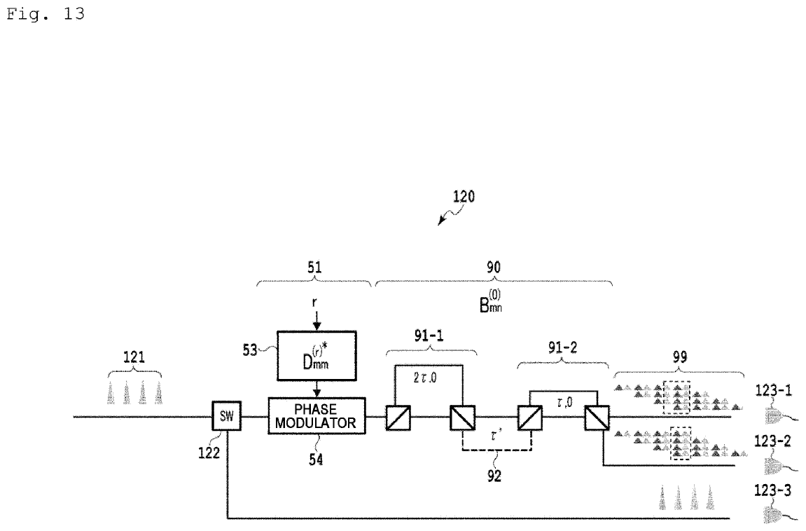

FIG. 13 is a diagram showing a configuration example of the MUB state measurement device including the computational basis. The MUB state measurement device 120 using the finite field has the same configuration as the measurement device 50-2 in which the two units shown in FIG. 6(b) are combined. A phase modulation unit 51 as a first unit, and a Hadamard transformed state measurement unit 90 corresponding to the right term Bₘₙ⁽⁰⁾ on the right side of equation (6) as a second unit. The Hadamard transformed state measurement unit 90 of FIG. 13 is the same as the Hadamard transformed state measurement unit 90 of configuration example 2 utilizing the delay line shown in FIG. 10(a).

The measurement device 50-2 of FIG. 6(b) is a projective measurement device for the quantum states of maximum d (r=0, 1, . . . , d−1) MUBs defined by equations (3) and (4). The state measurement device 120 of FIG. 13 can also measure the computational basis in addition to the d MUB states, and realizes (d+1) MUB measurements as a whole. Since the projective measurement to the computational basis is the measurement of the time at which the photons exist, the measurement may be performed directly by the photon detector without using an interferometer.

In order to measure the projection on the computational basis, in the state measurement device of FIG. 13, an optical SW 122 is provided on the input side, and when photons are sent to a photon detector 123-3, the projection on the computational basis is measured. When the photon (input continuous pulse 121) is sent to the phase modulation unit 51 side by an optical SW 122, projective measurement of a label r described by equations (3) and (4) to the MUB state is performed according to the modulation by the phase modulator 54. Therefore, in the state measurement device 120 of FIG. 13, the optical SW 122 and the phase modulator 54 play a role of switching and selecting different (d+1) MUBs.

It is needless to say that the Hadamard transformed state measurement unit 90 of the second unit can be replaced by another configuration in the configuration of the state measurement device of FIG. 13. The Hadamard transformed state measurement unit 90 of the state measurement device unit of FIG. 13 can be replaced by any of configuration examples 1 to 4 described in FIGS. 8 to 12. Further, if the switching between the computational basis and the other bases may be random, for example, as in the application or the like to the QKD, the optical SW may be replaced by an optical splitter having an appropriate splitting ratio.

### State Measurement Device of MUB Using Finite Field: Specific Configuration 2

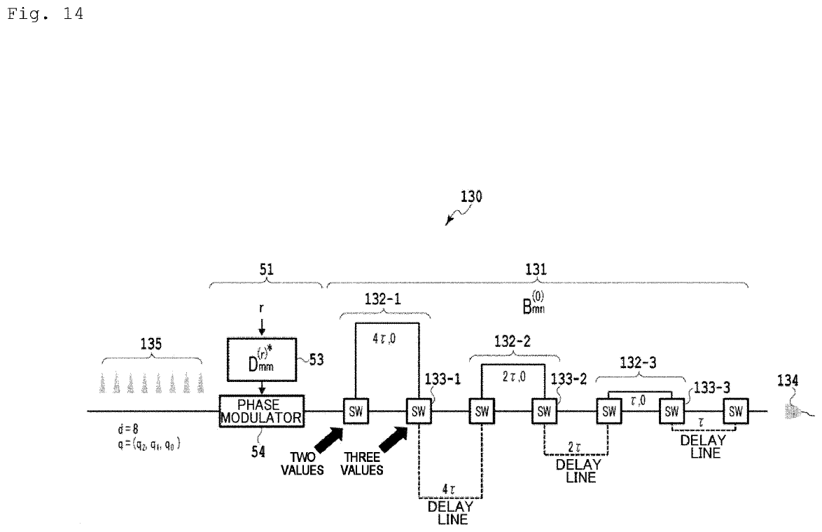

FIG. 14 is a diagram showing another example configuration of the MUB state measurement device utilizing a finite field. The state measurement device 130 of FIG. 14 also has the same configuration as the measurement device 50-2 shown in FIG. 6(b), and includes a phase modulation unit 51 as a first unit and a Hadamard transformed state measurement unit 131 corresponding to Bₘₙ⁽⁰⁾ as a second unit. The Hadamard transformed state measurement unit 131 of FIG. 14 is a modification of a part of the Hadamard transformed state measurement unit 100 of configuration example 3 shown in FIG. 11.

The optical SW used in the Hadamard transformed state measurement units of configuration examples 3 and 4 does not only simply switch the relation between the input and output, but also can play the same role as the beam splitter by adjusting the control conditions. Such an optical SW has three output states including split (half mirror state) in addition to transmission and blocking (reflection).

In the Hadamard transformed state measurement unit 131 in the state measurement device 130 of FIG. 14, MZI units 132-1 to 132-3 of three layers are cascade-connected, and the respective layers are connected in parallel by delay lines, and the configuration is the same as that of configuration example 3. However, the output side couplers of the MZI unit of each layer are replaced by optical SW 133-1 to 133-3 including the state of output light distribution. The replaced optical SW in the state of split (half mirror) performs effectively the same operation as the output coupler of the MZI whose phase difference is set to 0. Therefore, the Hadamard transformed state measurement unit 131 of FIG. 14 and the Hadamard transformed state measurement unit 100 of FIG. 11 can operate in the same manner.

Further, considering a state in which the state measurement device shown in FIG. 14 does not perform the time switching operation of all the optical SW and pulses are sent only to any one of the fixed paths, it is understood that the MZI unit in this state functions as an only delay line. In such a state, since no interference occurs in the input continuous pulse 135, the measurement by the state measurement device of FIG. 14 corresponds to the projective measurement to the computational basis. Therefore, even in the configuration of the state measurement device 130 of FIG. 14, it is possible to measure (d+1) MUBs including the computational basis. According to the configuration of the state measurement device 130, it is possible to measure the states of all the MUBs including the computational basis by only one photon detector 134. The advantage that the value of the phase difference may be arbitrary with respect to the delay line indicated by the dotted line, and the stabilization of the phase difference in the delay line is not required is the same as that of the Hadamard transformed state measurement unit of configuration example 3 of FIG. 11. As shown in FIG. 14, the number of states to be taken by each optical SW may be only two values (transmission/reflection state) on the input side of the MZI unit of each layer and three values (transmission/reflection/half mirror state) on the output side.

It is needless to say that the replacement of the output coupler in the MZI unit with the optical SW for realizing the split state can also be applied to the Hadamard transformed state measurement unit 110 according to configuration example 4 of the loop-like configuration of FIG. 12.

### Configuration for Each State Generation Device of MUB Using Finite Field

In FIGS. 6 to 14, various configuration examples of the MUB state measurement device utilizing the finite field have been presented. Here, the approach from the configuration of the state measurement device is presented again for the state generation device of the MUB. In the case of the most basic two-dimensional time-bin quantum bit, a configuration realized by an interferometer and a phase modulator is widely used as a method for generating the state of the MUB.

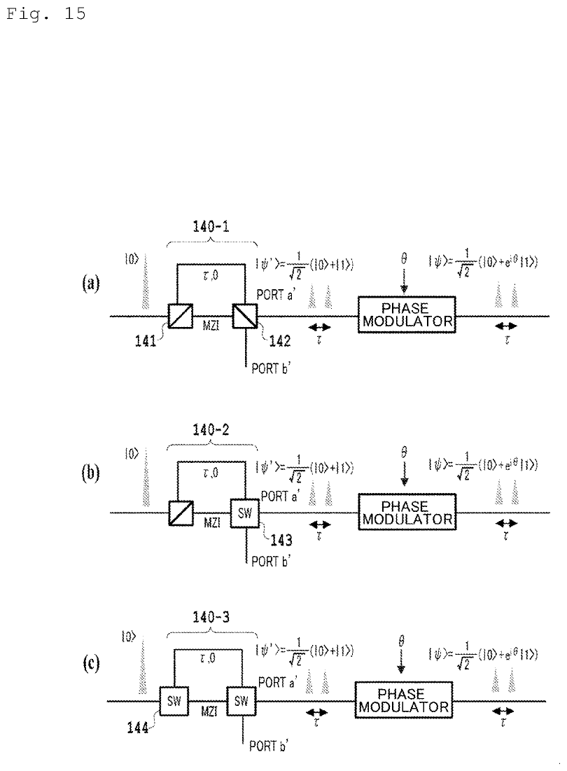

FIG. 15 is a diagram for explaining the MUB state generation of the two-dimensional time-bin quantum bit. FIG. 15(a) is a configuration of a generation device currently used for generating the MUB state of the two-dimensional time-bin quantum bit. Comparing the configuration of the state generation device 30 shown in FIG. 4 with the configuration of FIG. 15(a), the intensity modulator 31 shown in FIG. 4 is replaced by an interferometer 140-1 in FIG. 15(a). The interferometer is an MZI, which is made up of an input side coupler 141, two arm waveguides whose delay time is set to τ, and an output side coupler 142. By using the interferometer 140-1, a superposed state of two continuous pulse is realized at a time interval τ.

The state generation device 30 shown in FIG. 4 can be used for generating a state with a pseudo single photon using weak coherent light allowed by QKD or the like. However, in the case where a true single photon source is used in the state generation device 30 shown in FIG. 4, a device for producing a superposed state with respect to a temporal position is required separately. The method using the interferometer 140-1 of FIG. 15(a) has an advantage that the interferometer can be used for a true single photon source because the superposed state of the temporal position itself is created by the interferometer.

In the configuration of FIG. 15(a), since the photons output to the port b′ are lost, even if an ideal device is used, the state generation fails at a probability of 1/2. Therefore, as shown in FIG. 15(b), when the output side coupler (beam splitter) 142 of the subsequent stage is replaced by the optical SW 143, and the optical SW 143 is not output to the port b′, the state can be generated with probability 1 in principle.

Further, as shown in FIG. 15(c), when the input side coupler is also replaced by the optical SW 144 and all the couplers of the interferometer 140-3 are replaced by the optical SW, all MUBs including not only the superposed state of the temporal position but also the temporal position state |0>, |1> can be generated.

The points to be noted in the configuration of the device for generating the two-dimensional MUB state described above are points that each configuration of FIG. 15 reverses the arrangement order of the constituent elements of the state measurement device for the high-dimensional MUBs of the present disclosure previously described in FIGS. 6 to 14 with a similar configuration in the two-dimensional case.

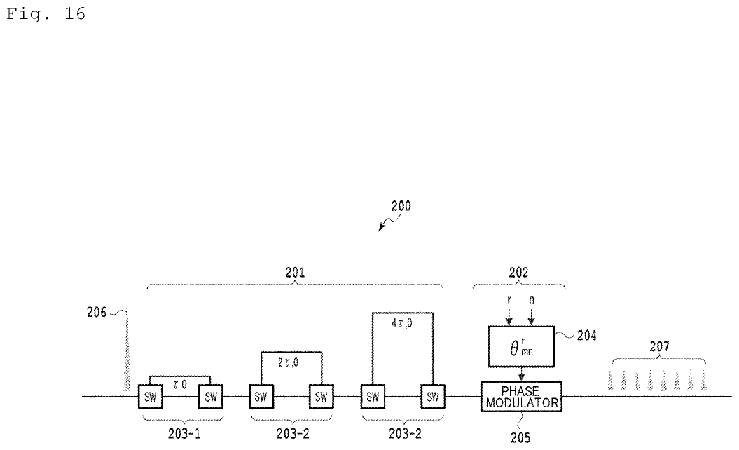

FIG. 16 is a diagram for explaining a MUB state generation device for 8-dimensional time-bin quantum bits. The MUB state generation device 200 utilizing the finite field is obtained by extending the MUB state generation device of the two-dimensional time-bin quantum bit shown in FIG. 15(c) to an 8-dimensional time-bin quantum state. At the same time, the constituent elements of the state measurement device described above are disposed in the reverse order. That is, in the state generation device 200 of FIG. 16, the constituent elements of the state measurement device 130 of FIG. 14 are disposed in reversed order. More specifically, the delay processing unit 201 including an MZI unit 203-1 having a delay time τ, an MZI unit 203-2 having a delay time 2τ, and an MZI unit 203-3 having a delay time 4τ, and the phase modulator 202 are disposed in this order. The state measurement device 200 of FIG. 16 can generate all states of the nine MUBs including the computational basis in the case of eight dimensions with respect to the input of the single photon 206.

The state generation device 200 of FIG. 16 does not include the delay line of the state measurement device 130 of FIG. 14. This is because, even if there is a delay line, the state is the same as that in the absence of the delay line by the switching operation of the optical SW. Therefore, the constituent elements of the measurement device of FIG. 14 may be disposed in reversed order and diverted to the generation device as they are, or unnecessary delay lines may be deleted. Similarly, when the state measurement devices of FIGS. 6 to 13 are configured as they are or a delay line is removed, and the order of arrangement of constituent elements is reversed, the present invention can be applied to the state generation device in the same manner as in FIG. 14.

For example, the delay processing unit 201 of FIG. 16 may be replaced by a configuration which is made up of a plurality of optical interferometers disposed in an inversed tree shape with N layers from the input side to the output side by reversing the arrangement of the Hadamard transformed state measurement units 80 of the tree-like configuration example 1 shown in FIG. 8. At this time, light may be input to one port of the interferometer located at the most input side. Similarly, the delay processing unit 201 of FIG. 16 may be replaced by a configuration in which the Hadamard transformed state measurement unit 100 of configuration example 3 including a plurality of interferometers connected in cascade shown in FIG. 11 is disposed in the reverse order. At this time, there is no need for a delay line between layers of the interferometer. In the Hadamard transformed state measurement unit 110 of configuration example 4 of FIG. 12, the delay processing unit 201 of FIG. 16 is similarly replaced by the configuration in which the input/output relationship is reversed.

However, in the case of the Hadamard transformed state measurement unit 90 of configuration example 2 using an interferometer cascade-connected without using the optical SW of FIG. 10, the delay line must be removed. This is because the number of pulses more than the assumed dimension is generated by the influence of the delay line. As described above, when the optical SW is used, since the effect of the delay line can be eliminated, the delay line can remain and the same device can be completely used. In the case of the tree-like configuration example 1, there is no delay line originally, and therefore there is no problem.

Although there is an optical interferometer that is not used on the lower layer of the tree in the above-mentioned configuration including a plurality of optical interferometers disposed in an inverted tree shape in the N layer, it is also possible to make the whole compact, for example, using one tree-like optical interferometer for both the generation device and the measurement device in combination with an optical circulator.

Therefore, another state generation device of the present disclosure is a time-bin quantum state in which the orthogonal light state corresponds to each pulse of d continuous pulses trains to the state of a computational basis and utilizes an orthogonal mode of time, and is implemented to include a configuration 201 of any one of a first configuration (reverse arrangement of Hadamard transformed state measurement unit configuration example 1) which is a plurality of optical interferometers disposed in an inverted tree form with N layers from the input side to the output side, each of the plurality of optical interferometers having a delay time corresponding to the layer position of the N layers, a second configuration (reverse arrangement of same configuration example 3) including a plurality of optical interferometers cascade-connected to N layers, each of the plurality of optical interferometers having a delay time corresponding to the layer position of the N layers, or a third configuration (reverse arrangement of configuration example 4) which includes an optical interferometer connected in a loop, the optical interferometer having a variable delay time corresponding to the number of laps, and a phase modulator 202 which is connected to the last stage of any of the above configurations and applies the phase modulation to each of the pulses based on the information r of the basis and the information of label n of the state in the basis.

### Quantum Key Generating System by MUB State Generation/Measurement Device Using Finite Field

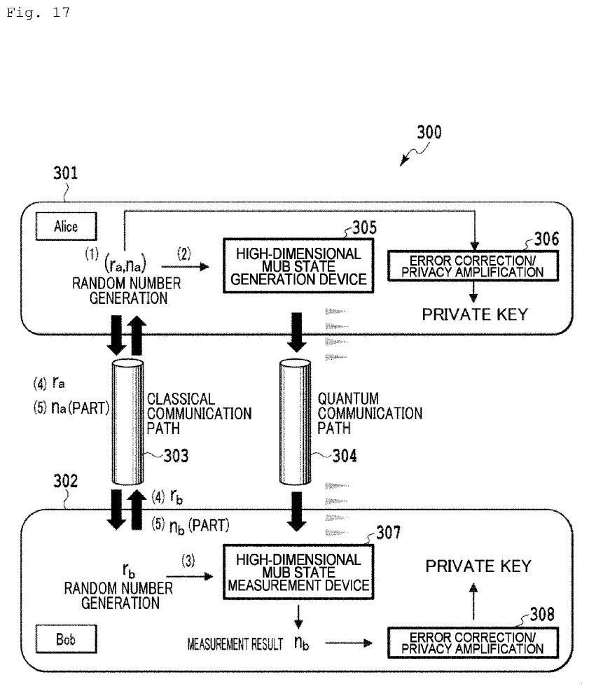

FIG. 17 is a diagram showing a quantum key distribution system based on the MUB quantum state utilizing a finite field. The above-described high-dimensional MUB state generation device and measurement device can be used as a high-dimensional quantum key distribution system 300 as follows. The high-dimensional quantum key distribution system 300 includes a sender side block 301, a receiver side block 302, and a classical communication path 303 and a quantum communication path 304 for connecting both blocks. The sender side block 301 includes a high-dimensional MUB state generation device 305 and an error correction/privacy amplification processing unit 306. The receiver side block 302 includes a high-dimensional MUB state measurement device 307 and an error correction/privacy amplification processing unit 308. In the high-dimensional quantum key distribution system 300, quantum key distribution is performed in the following procedure.
Step 1: Sender Alice 301 randomly selects a basis r=ra from (d+1) MUBs, and then randomly selects state n=nₐ among them.
Step 2: Information of (rₐ, nₐ) pairs is input to the MUB state generation device 305 utilizing a finite field, and the generated state is sent to a receiver Bob 302 through the quantum communication path 304.
Step 3: The receiver Bob 302 randomly selects the basis r=r_{b} in the same manner as Alice, and inputs it into the MUB state measurement device 307 utilizing a finite field together with the state sent from Alice, thereby obtaining the measurement result n=n_{b}.
Step 4: Steps from state generation to state measurement Steps 1 to 3 are repeated, and in an array of the obtained state n, Alice and Bob disclose information on the basis r to each other via the classical communication path 303, and the sifted key is obtained by leaving only n when they match.
Step 5: Alice and Bob disclose the results of a few test bits of the sifted key to estimate each other's nₐ, n_{b} distributions or simplified non-match probabilities (error rates).
Step 6: The bit error correction and privacy amplification used to obtain a secure matched key is performed on the remaining sifted key to generate a secret key for use in cryptographic communication, based on the estimated distribution or non-match probability.

The advantage of this quantum key distribution system 300 for the high-dimensional quantum key distribution system of the related art is that all the MUB can be utilized in any 2^{N}-dimension. As compared with a quantum key distribution system using only two kinds of MUBs (for example, NPL 4), the quantum key distribution system 300 can improve the error rate tolerance.

Although the protocol of quantum key distribution in Steps 1 to 6 is the most basic protocol, as long as the state generation device and measurement device of the MUB utilizing the finite field of the present disclosure are utilized, extension using a decoy method or the like widely used in two-dimensional quantum key distribution can be applied, and the above-mentioned effect of improving error rate tolerance can be obtained.

Also, the choice of the basis selection in the above Steps 1 to 6 can be reduced from the maximum (d+1) to the minimum 2. In this case, the effect of improving the error rate tolerance caused by the number of options of the bases decreases. Instead, for example, by not using the time base, the photon detector 123-3 in the state measurement device 120 shown in FIG. 13 is not required, and the quantum key generating system can be further simplified. Also in this case, since the dimension d increases, it is possible to obtain an advantage as compared with a quantum key distribution system using only two-dimensional MUBs.

### Quantum Key Distribution System by MUB State Measurement Device Using Entangled State and Finite Field

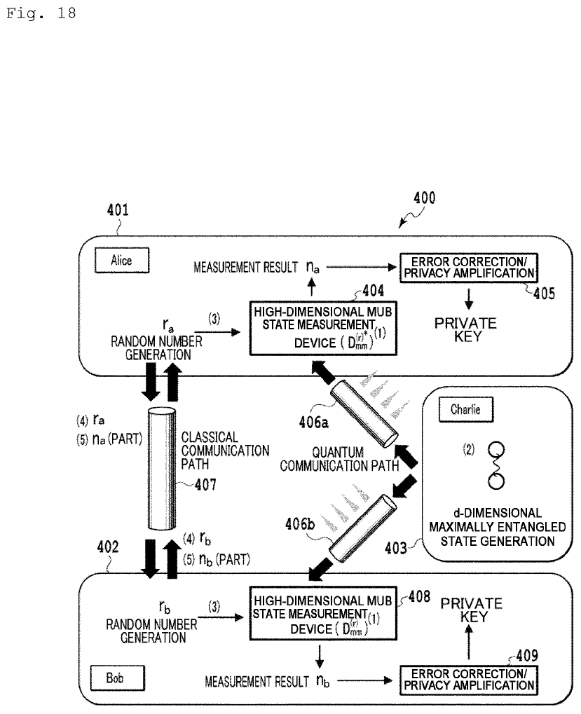

FIG. 18 is a diagram showing another example of a quantum key distribution system by the MUB quantum state utilizing a finite field. As a method of QKD, there is a known method in which a third party Clarlie shares the maximally entangled quantum state between Alice and Bob, and the both share a secret key by performing measurements. The above-described high-dimensional MUB state measurement device can also be used as the following high-dimensional quantum key distribution system 400. The quantum key distribution system 400 includes a sender side block 401, a receiver side block 402, a third party block 403, and a classical communication path 407 and quantum communication paths 406a and 406b for connecting three parties. The sender side block 401 includes a high-dimensional MUB state measurement device 404 and an error correction/privacy amplification processing unit 405. The receiver side block 402 also includes a high-dimensional MUB state measurement device 408 and an error correction/privacy amplification processing unit 409.

In the high-dimensional quantum key distribution system 400, the MUB state measurement device utilizing the finite field described above can be used in the following procedure.
Step 1: Alice and Bob prepare the high-dimensional MUB state measurement devices 404 and 408, respectively. However, one (Alice) of them sets Dₘₘ^{(r)*} as the modulation signal to the phase modulator, and the other (Bob) sets Dₘₘ^{(r)} as the modulation signal to the phase modulator.
Step 2: Charlie generates the d-dimensional maximally entangled state according to the following equation, and sends one photon to Alice and the other photon to Bob through quantum channels 406a and 406b.

$${\vert Ψ 〉 = \frac{1}{\sqrt{d}} {\sum }_{i} \vert i , i 〉}_{A , B} \qquad Equation ( 12 )$$

Step 3: Alice and Bob each randomly select a basis r=rₐ, r=r_{b} from (d+1) MUBs. The selected basis information and photons received from the Charlie are input to high-dimensional MUB state measurement devices 404 and 408 to obtain each of measurement results na and nb.
Step 4: The process from the state generation to the measurement in steps 2 to 3 is repeated, and in an array of the obtained state n, Alice and Bob disclose the information of the bases r mutually through the classical communication path, and the sifted key is obtained by leaving only n when they match.
Step 5: Alice and Bob disclose the results of a small number of test bits of the sifted key to estimate distributions of each other's nₐ, n_{b} or simplified non-match probabilities (error rates).
Step 6: Bit error correction and privacy amplification used to obtain a secure matched key are performed on the remaining sifted keys to generate a secret key to be used for cryptographic communication, based on the estimated distribution or error rate.

In the high-dimensional quantum key distribution device of the related art, in the case of prime dimensions, QKD utilizing all MUB and entanglement is implemented by utilizing the orbital angular momentum of light (for example, NPL 5). The advantage of the high-dimensional quantum key distribution system 400 compared to the quantum key distribution system of the related art is that all the MUBs can be utilized in an arbitrary 2^{N}-dimension like the quantum key distribution system 300 of FIG. 17, and a high effect of improving error rate resistance can be expected.

Further, by utilizing the entanglement, the number of random numbers necessary for operating the quantum key distribution system can be reduced, and the light source can be prepared by an unreliable third party, and the same advantage as the QKD utilizing the quantum entanglement in the two-dimensional case can be obtained.

### High-Dimensional Quantum State by MUB Using Finite Field of Power Dimension of Odd Prime P

The state generation device and the state measurement device by MUB utilizing the finite field have been described for the case where the dimension d=2^{N}. Assuming a case where p is an odd prime and the dimension is d=p^{N}, the probability amplitude Bₘₙ^{(r)} is given by the following equation (NPL 2).

$${B}_{mn}^{( r )} = \frac{1}{\sqrt{{p}^{N}}} exp ( \frac{2 π}{p} i ( {\sum }_{j = 0}^{N - 1} {r}_{j} {m}^{T} {A}^{( j )} m + m \cdot n ) ) \qquad Equation ( 13 )$$

In the same manner as in equation (4), m, n, and r are defined as follows.
m: A label that defines the state of the computational basis
n: A label that defines the state of mutually unbiased bases (MUBs)
r: A label of MUBs

In parentheses including the τ of equation (13), r, m, and n (bold character) represent vectors when the integers r, m, and n are expressed in p-adic representation so that each element is an element of a finite field of order p. Further, rⱼ (bold character) is a scalar amount indicating the j-th element when r is vectorized by a p-adic representation. m^{T} (bold character) is a horizontal vector, A^{(j)} is a square matrix, and m (bold character) is a vertical vector.

Similarly, an element which is a basis of a finite field of the order p^{N} where only the i-th element becomes 1 is defined as fᵢ, and the symmetry matrix A^{(j)} is defined as a matrix satisfying equation (2) similarly to the case of a finite field of the order 2^{N}. Here, if p=2 is substituted in equation (13), it is not the same as equation (4) in the case of the finite field of the order 2^{N}, and when p is an odd prime, another handling is required. Since the calculation in the parenthesis inside equation (13) is the calculation of the finite field of the order p, the product and sum of integers are simply performed followed by the mod p operation. Further, since the phase in the exponential function is an integer multiple of 2π/p, the calculation of mod p can be omitted, and only the product-sum calculation of integers is sufficient.

According to equation (13), the phase of the probability amplitude Bₘₙ^{(r)} when d=p, in which p is an odd prime, takes a value that is an integer multiple of 2π/p. For example, when the dimension p is 3¹=3, it can be seen that only three values of 0, 2π/3, and 4π/3 are taken. Even if the dimension p is further increased and 32-9 and 33-27, only three values are taken, and the resolution of the phase is only one third of 2π. The problem in the MUB based on the Fourier transformed basis expressed by equation (1), which is the related art, that extremely high phase resolution is required as the dimension d increases can be greatly solved. Further, the state generation of the MUB by the dimension d=3^{N} where p=3 of the odd prime is more excellent in that the phase resolution is further relaxed than the resolution in the case of the dimension d=2^{N} where the probability amplitude is expressed by equation (4) and the phase value takes four values (resolution 1/4). As will be described later, the state generation of the MUB by the dimension d=^{N}, which is generally defined as the odd prime p, is superior to the state generation of the MUB by the Fourier transformed basis expressed by equation (1).

### State Generation Device by MUB Using Finite Field of Power Dimension of Odd Prime p

The configuration of the state generation device of the MUB utilizing a finite field of dimension d=p^{N} (p: odd prime), in which the probability amplitude is expressed by equation (13), may be the same as that of the state generation device 30 of FIG. 4 and the state generation device 40 of FIG. 5. In FIGS. 4 and 5, only the modulation signals 36 and 45 applied from the modulation signal generators 33 and 42 are different because the phases set to the phase modulators 32 and 41 are different. Therefore, the configuration of the state generation device can utilize a quantum state generation device utilizing the MUB defined by equations (2) to (4) as it is.

### State Measurement Device by MUB Using Finite Field of Power Dimension of Odd Prime p

Next, a state measurement device will be considered. Even in the MUB by the finite field of dimension d=p^{N} (p odd prime) expressed by equation (13), the probability amplitude Bₘₙ^{(r)} is decomposed into two matrix components in the same manner as discussed in equation (6), and each matrix can be divided into corresponding units to implement the state measurement device.

More specifically, the probability amplitude Bₘₙ^{(r)} according to equation (13) can also be decomposed into two elements, that is, Dₘₘ^{(r)} on the left term in the right side of equation (6) and Bₘₙ⁽⁰⁾ on the right term in the right side of equation (6). Considering the decomposition similarly to the case of d=2^{N} as p=2, Dₘₘ^{(r)}, which is the first unit, is a phase modulation unit with p values.

On the other hand, in the probability amplitude Bₘₙ⁽⁰⁾ according to equation (13), for Bₘₙ⁽⁰⁾ serving as the second unit, the p-ary expression corresponding to 0 of the integer r in an arbitrary p dimension is a vector in which N pieces of 0 are disposed. Therefore, since the rⱼ of the Σ term in the parentheses in equation (13) becomes 0, the π term disappears and Bₘₙ⁽⁰⁾ becomes the following equation.

$${B}_{mn}^{( 0 )} = \frac{1}{\sqrt{{p}^{N}}} exp ( \frac{2 π}{p} im \cdot n ) \qquad Equation ( 14 )$$

Equation (14) corresponds to Bₘₙ⁽⁰⁾ in the case of dimension d=2^{N}, but this is equivalent to the Fourier transform for each p-dimensional quantum state, considering the quantum state of the dimension of p^{N} as an N-particle p-dimensional quantum state by an equivalent p-dimensional quantum state. Therefore, when the two-dimensional Hadamard transform in the case of d=2^{N} is replaced by a p-dimensional Fourier transform, and the tensor product of |+> and |−> states in the projective measurements is replaced by N tensor products of p states |f₀>, |f₁>, . . . . |fₚ₋₁>, the same discussion as the state measurement of the MUBs of dimension d=2^{N} is established.

As an example, a 9-dimensional case (d=3², N=2, p−3) will be considered. At this time, the quantum state of the 9-dimensional computational basis is defined as |0>, |1>, |2>, |3>, |4>, |5>, |6>, |7>, and |8>. A two-particle three-dimensional quantum state (N-particle p-dimensional state) equivalent to these quantum states is considered. That is, by utilizing the p-adic representation of equivalent two particles, each state of |00>, |01>, |02>, |10>, |11>, |12>, |20>, |21>, |22> of the quantum states of the qudits of the two particles are associated with the quantum states of the nine quantum states. A quantum state of a p-number in three-dimensions or more is called qudit while it is called qubit for a two-dimensional case with a binary number described in the case of a MUBs in dimensions of d=2^{N}.

In the MUBs by the finite field of dimension d=p^{N} (p-odd prime) expressed by equation (13), the necessary projective measurement in the case of p=3 becomes the tensor product state of the three-dimensional Fourier transformed basis. Specifically, the necessary projections of the three-dimensional Fourier transformed basis are the following three states |f₀>, |f₁>, |f₂>.

$$\vert {f}_{0} 〉 = \frac{1}{\sqrt{3}} {\sum }_{m = 0}^{2} {e}^{\frac{0 im}{3}} \vert m 〉 = \frac{1}{\sqrt{3}} {e}^{\frac{0 i}{3}} \vert 0 〉 + \frac{1}{\sqrt{3}} {e}^{\frac{0 i}{3}} \vert 1 〉 + \frac{1}{\sqrt{3}} {e}^{\frac{0 i}{3}} \vert 2 〉 \qquad Equation ( 15 - 1 )$$

$$\vert {f}_{1} 〉 = \frac{1}{\sqrt{3}} {\sum }_{m = 0}^{2} {e}^{\frac{2 π im}{3}} \vert m 〉 = \frac{1}{\sqrt{3}} {e}^{\frac{0 i}{3}} \vert 0 〉 + \frac{1}{\sqrt{3}} {e}^{\frac{2 π i}{3}} \vert 1 〉 + \frac{1}{\sqrt{3}} {e}^{\frac{2 π i}{3}} \vert 2 〉 \qquad Equation ( 15 - 2 )$$

$$\vert {f}_{2} 〉 = \frac{1}{\sqrt{3}} {\sum }_{m = 0}^{2} {e}^{\frac{4 π im}{3}} \vert m 〉 = \frac{1}{\sqrt{3}} {e}^{\frac{0 i}{3}} \vert 0 〉 + \frac{1}{\sqrt{3}} {e}^{\frac{4 π i}{3}} \vert 1 〉 + \frac{1}{\sqrt{3}} {e}^{\frac{4 π i}{3}} \vert 2 〉 \qquad Equation ( 15 - 3 )$$

In the case of the Fourier transformed basis, the basis state expressed by equation (14) is expressed by the tensor product of the above three states |f₀>, |f₁>, |f₂>. Therefore, in the case of MUBs by a finite field of dimension d=p^{N} (p-odd prime), the transformation of Bₘₙ⁽⁰⁾ of the second unit in FIG. 6 is an operation of performing a p-dimensional Fourier transform on all equivalent qudits, each of which is a digit decomposed from a p-ary expression as N-particle p-dimensional quantum states equivalent to the quantum state of the measurement object. Therefore, in the state measurement device of the MUBs by the finite field of dimension d=p^{N} (p-odd prime), the second unit 52 of FIG. 6(b) becomes a p-dimensional Fourier transformed state measurement unit.

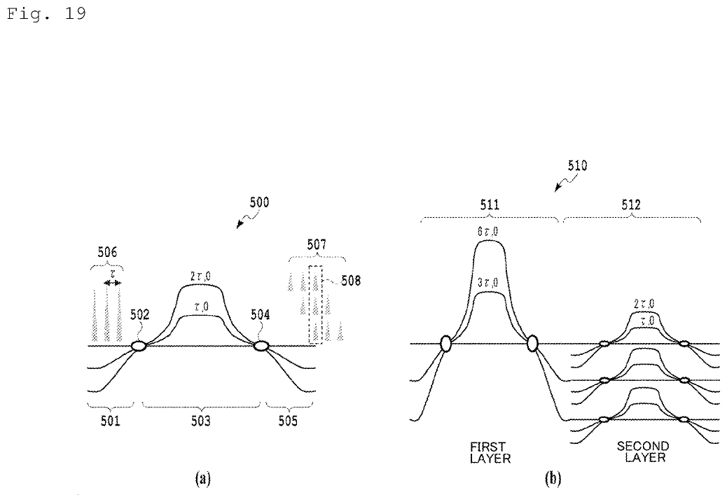

FIG. 19 is a diagram for explaining the configuration of the p-dimensional Fourier transformed state measurement unit. FIG. 19(a) shows the configuration of a three-dimensional Fourier transform state measurement unit using a multi-arm delay interferometer (multi-arm delay interferometer). It is known that the Fourier transformed measurement for the p-dimensional time-bin quantum state can be configured using a multi-arm delay interferometer having p arms (NPL 6). The Fourier transformed state measurement unit 500 is a multi-arm delay interferometer having three arms, and includes three input waveguides 501, an input coupler 502, three arm waveguides 503 having different lengths, an output coupler 504, and three output waveguides 505. The three arm waveguides 503 have delay times of 0, τ, and 2τ.

Input continuous pulses 506 with a time interval τ are input to the Fourier transformed state measurement unit 500, and an output pulses 507 of the superposed state are also obtained from any output port at time intervals of t corresponding to the delay time of the arm waveguide 503. In the dotted line region 508, all the input pulses of the input continuous pulse 506 appear, and the superposed state of the three input pulses is obtained. That is, the input photons are projected and measured to the state of the following equation in which the temporal position states |0>, |1>, |2> of the input pulses are equally superimposed at the relative phase 0).

$$\vert ψ 〉 = \frac{1}{\sqrt{3}} {\sum }_{i} \vert i 〉 \qquad Equation ( 16 )$$

The state of the above equation (16) is the same as the basis state |f₀> of equation (15-1) among the three states of the above three-dimensional Fourier transformed basis. At this time, projective measurements to the remaining basis states in the Fourier transformed basis are realized at the other two output ports according to the phase relation between the input port and output ports of the 3-input 3-output interferometer 500. Therefore, at the time of the dotted line region 508, it is possible to determine to which state of the three states of equations (15-1) to (15-3) the projective measurement is performed by information on which output port the photon was detected by the photon detector.

In order to extend the p-dimensional Fourier transform measurement by the multi-arm delay interferometer to p^{N} dimensions, for example, if it is 9 dimensions, a plurality of multi-arm delay interferometers may be disposed in a tree shape of two layers (N layers) and connected, as described in the configuration of the Hadamard transform unit in FIG. 8.

FIG. 19(b) shows a two-particle three-dimensional Fourier transformed state measurement unit by a multi-arm delay interferometer having a tree-like configuration. The two-particle three-dimensional Fourier transformed state measurement unit 510 includes a first layer multi-arm delay interferometer 511 and a second layer multi-arm delay interferometer 512. The first layer multi-arm delay interferometer 511 includes three arm waveguides having relative delays of 6 τ, 3τ, and 0. The multi-arm delay interferometer 512 including three arm waveguides having relative delays of 2τ, τ,and 0 is connected to each of the three output ports of the multi-arm delay interferometer 511.

In the case of the configuration of dimension d=9 (3²) in which the three-input multi-arm delay MZI shown in FIG. 19(b) is realized by a two layer configuration, nine photon detectors 1 to 9 (not shown) are provided at the output ports of the three MZI 512 of the second layer. The relationship between the photon detection and the projected state in each photon detector is as follows.

When a 9-dimensional quantum state is expressed as an equivalent 2-particle 3-dimensional quantum state by qudit, according to the information on which photon detector a photon is detected, it is possible to determine which state projective measurement of tensor products of the 3-dimensional quantum state shown by equations (15-1) to (15-3) on the equivalent qudits is performed.
Photon detection at photodetector 0->|f₀, f₀> state
Photon detection at photodetector 1->|f₀, f₁> state
Photon detection at photodetector 2->|f₀, f₂> state
Photon detection at photodetector 3->|f₁, f₀> state
Photon detection at photodetector 4->|f₁, f₁> state
Photon detection at photodetector 5->|f₁, f₂> state
Photon detection at photodetector 6->|f₂, f₀> state
Photon detection at photodetector 7->|f₂, f₁> state
Photon detection at photodetector 8->|f₂, f₂> state

As described above, the two-particle three-dimensional Fourier transformed state measurement unit shown in FIG. 19(b) corresponds to configuration example 1 of the Hadamard transformed state measurement unit of tree structure in the state measurement of the MUB by a finite field of dimension d=2^{N}. Other configuration examples (FIGS. 8, 10, 11 and 12) of the Hadamard transformed state measurement unit can also be applied to the Fourier transformed state measurement unit of the state measurement of the MUBs by a finite field of dimension d=p^{N} (p-odd prime).

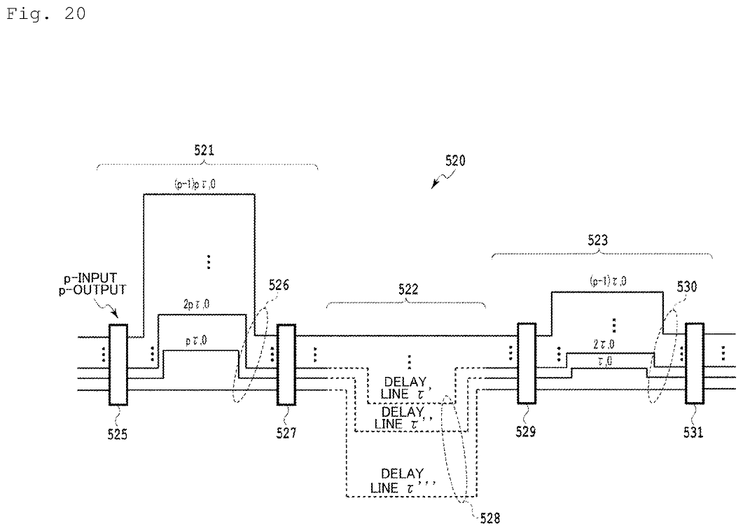

FIG. 20 is a diagram showing the configuration of a two-particle p-dimensional Fourier transformed state measurement unit using a delay line. A Fourier transformed state measurement unit 520 of FIG. 20 corresponds to configuration example 2 of the Hadamard transformed state measurement unit 90 utilizing a delay line in the state measurement of the MUB by a finite field of dimension d=2^{N} of FIG. 10. In the Fourier transformed state measurement unit 520, two multi-arm delay interferometers 521 and 523 are cascade-connected. That is, the multi-arm delay interferometer 521 including the p-arm waveguide of the first layer and the multi-arm delay interferometer 523 including the p-arm waveguide of the second layer are cascade-connected via a delay line unit 522. The multi-arm delay interferometer 521 of the first layer is made up of an input side coupler 525 of p-input and p-output, p arm waveguides 526 of different lengths, and an output side coupler 527 of p-input and p-output. The second layer multi-arm delay interferometer 530 has the same configuration as that of the first layer, and includes an input side coupler 529 of p-input p-output, p arm waveguides 530 having different lengths, and an output side coupler 531 of p-input p-output. The p arm waveguides of the multi-arm delay interferometer 521 of the first layer have delay times of (p−1) pτ . . . 2pτ, pτ, and 0. The p-arm waveguides of the second layer multi-arm delay interferometer 530 have a delay time of (p−1)τ . . . 2τ, α, 0.

The multi-arm delay interferometers of the two layers are connected by a delay line unit 522 including p delay lines having different delay times. Delay times τ′, τ″, . . . τ′″ different from the time interval τ of the input continuous pulses are set to the p-1 delay lines.

In the Fourier transformed state measurement unit 520 of FIG. 20, the superposed state of the input continuous pulses of dimension d=p² is generated at a prescribed observation time by the configuration including the delay line. Similarly to the explanation in FIG. 10(b), it is possible to determine which state of the p²-dimensional quantum state the projective measurement is performed by a combination of information on which photon detector among the p photon is detected and observation timing among the p photon. For example, if p=3 in FIG. 20, three photon detectors are provided at three outputs of the multi-arm delay interferometer of the second layer, and photons are detected at any one of three timings at which a superposed state d=9 (=3²) input continuous pulse occurs.

By combining the Fourier transformed state measurement units described in FIGS. 19 and 20 with the phase modulation unit disposed on the front stage side, a state measurement device having the same configuration as that described in FIG. 6(b) can be realized. That is, similarly to the measurement device 50-2 of FIG. 6(b), it can be realized by the phase modulation unit 51 which is the first unit on the front stage side, and the measurement unit 52 which corresponds to the Bₘₙ⁽⁰⁾ which is the second unit. However, the measurement unit 52 corresponding to Bₘₙ⁽⁰⁾ corresponds to equation (14), and performs the projective measurements to the tensor product of N-particles of p states |f₀>, |f₁>, . . . . |fₚ₋₁> with respect to the received d-dimensional quantum state. Here, the basis state of the received d-dimensional quantum state is expressed by N tensor products among p states |f₀>, |f₁>, |fₚ₋₁>. The second unit of FIG. 6(b) performs the projective measurement on the N-particle tensor product state of the p-dimensional Fourier transformed basis in d=p^{N} dimension (p odd prime), using the Fourier transformed state measurement unit of FIGS. 19 and 20, in contrast to the projective measurement to the state in which d=2^{N}-dimensional Hadamard transform is performed on the computational basis.

In the generation and state measurement of the high-dimensional MUB using the Fourier transformed basis |fₙ> of the related art shown in equation (1), there is a problem that high phase resolution is required as the dimension d increases. Therefore, in the state measurement of the MUB using the finite field of d=p^{N} dimension (p-odd prime), it may seem strange in that the Fourier transformed state measurement units of FIGS. 19 and 20 are used. However, focusing on the following points, the advantage can be understood that the Fourier transformed state measurement unit is used as the second unit of the state measurement device.

As the related art, in a high-dimensional MUB using the Fourier transformed basis |fₙ> shown in equation (1), as is apparent from the term “e” in equation (1), a phase proportional to 1/d with respect to the dimension “d” is provided. The state generation of the MUB requires phase modulation with very high resolution as the dimension d increases, and the same applies to the state measurement device.

On the other hand, the state measurement device of the present disclosure is decomposed into units (subsystems) corresponding to each of the two matrices, and the measurement unit 52 performs projective measurement on a tensor product of a p-dimensional Fourier transform which corresponds to the probability amplitude of equation (14) and is smaller than the d-dimensional one. In the example of p=3, the three states of the three-dimensional Fourier transformed basis used for the projective measurement includes |f₀>, |f₁>, |f₂>according to equations (15-1) to (15-3) obtained from equation (14). As is apparent from the term e in equation (14), even if the dimension d=p^{N} increases, the phase resolution is required according to the radix p, instead of depending on the dimension d. For example, in the Fourier transformed state measurement unit of the present disclosure, the required phase resolution is 1/5 of 2π even in the case where the radix p is 5 and the dimension d is 5²=25. On the other hand, in the state measurement of the high-dimensional MUB using the Fourier transformed basis |fₙ> of the related art shown by equation (1), the required phase resolution is 1/25 of 2π. In the case of p=11, the phase resolution required for the phase resolution has an extreme difference of 1/11 and 1/121 of 2π, and there is a large difference in the phase resolution required between the state measurement device of the related art and the state measurement device using the Fourier transformed state measurement unit of the present disclosure.

Such an advantage of the state measurement device utilizing the Fourier transformed state measurement unit of the present disclosure comes down to performing the projective measurement to the tensor product state of p states lf₀>, Ifi>, Ifp-1>, as a method of measuring a d-dimensional quantum state of dimension d=p^{N} of a measurement object. Here, the basis state of the d-dimensional quantum state is expressed by N tensor products among p states |f₀>, |f₁>, ··|fₚ₋₁>.

Similarly, the advantage of the state measurement device utilizing the Hadamard transformed state measurement unit of the present disclosure described above also comes down to performing the projective measurement of a two-dimensional base state (|+>, |−>) onto the tensor product state, as a method of measuring the d-dimensional quantum state of the dimension d=2% of a measurement object. The basis state of the received d-dimensional quantum state is expressed by a tensor product of two base states (|+>, |−>).

In the description of FIGS. 4 to 20, the state generation of the MUBs and the state measurement of the MUBs utilizing the finite field are described by utilizing the time-bin quantum state of light which is the orthogonal mode of time as the computational basis. However, even if a mode of light different from the time-bin quantum state is utilized, it is possible to generate a state of d=2^{N} dimension in equations (2) to (4) and a state of d=p^{N} dimensional (p-odd prime) MUBs obtained by replacing the probability amplitude Bₘₙ^{(r)} with equation (13). Also, even if different modes of light are used, the probability amplitude Bₘₙ^{(r)} is decomposed into two matrix constituent elements as shown in equation (6), and the state measurement device of the MUB can be realized by the corresponding two measurement units shown in FIG. 6(b). The two measurement units are a phase modulation part and a Hadamard transformed state measurement unit (d=2^{N} dimension) or a Fourier transformed state measurement unit (d=p^{N} dimension, p odd prime).

The term “mode of light” refers to a state of light which is physically orthogonal to each other, regardless of the type of freedom such as time, frequency, space, etc. When the quantum state is implemented as a physical element, there is, for example, a mode of light according to the following state.
(a) Time-bin quantum state: a state of light which can be distinguished in terms of time as a pulse
(b) Frequency-bin quantum state: a state of light which can be distinguished in terms of frequency
(c) A quantum state utilizing a spatial mode

The quantum state utilizing the above spatial mode (c) is, for example, the following quantum state.
Polarization: a state of light based on two orthogonal polarization states, such as vertical polarization/horizontal polarization
Orbital angular momentum: a state that is distinguishable orthogonally by intensity distribution/phase distribution in beam cross section
Propagation mode in the fiber: a state utilizing orthogonal propagation modes in the fiber, such as TE/TM mode
Utilizing optical path information: a state of light that is distinguishable by information, such as propagating through which core of a multi-core fiber and propagating through which optical path of an optical circuit

The state generation device and the state measurement device of the present disclosure are not limited to the type of mode of light which is a physical element for implementing equations (2) to (5) and (13) defining the MUBs. Furthermore, in the measurement device, the implementation of the two measurement units according to equations (6), (7) and (13) defining the matrix decomposed into two is not limited to the type of mode of light which is a physical element. Equations (2) to (4) and (13) defining the MUBs do not describe physical entities such as an electric field and a magnetic field. The description of FIGS. 4 to 20 is a case where the quantum states such as |0>, |1>, |2>, . . . . |d−1> in the above equations are mapped to a time-bin quantum state which is one of physical modes of light. Therefore, the above equations used for state generation and state measurement are completely common regardless of the type of mode of light. As an example of utilization of modes of light other than the time-bin quantum state, the state of high-dimensional MUB utilizing a finite field is shown in an example of utilization of a frequency-bin quantum state.

### Implementation of State Generation Device by Frequency-bin State

In the conventional quantum state generation device and measurement device of the MUBs utilizing the finite field of the present disclosure, a case of the time-bin quantum state using the orthogonal mode of time has been described as the computational basis. As described above, there is no limitation to the type of the mode of light which is a physical element for implementing the generation of the quantum state of equations (2) to (5) and (13) defining the MUB. In the measurement device, implementation by two measurement units based on equations (6), (7), and (13) does not similarly dependent upon the mode of light.

In another mode of light different from the time-bin quantum state as a computational basis, there is a frequency-bin quantum state using an orthogonal mode of the frequency of light as a computational basis (NPLs 7 and 8). The frequency-bin quantum state utilizes a plurality of lights of different frequencies that are present within a predetermined time period as a computational basis. Therefore, in the light of the d-dimensional frequency-bin quantum state, the light at any of the d frequency positions arranged on the frequency axis is treated as a computational basis instead of the d pulse positions arranged on the time axis obtained by the time-bin quantum state generation device of FIG. 4. As long as the frequency width of each light is sufficiently narrower than the frequency interval Δf, since the d lights can be distinguished, a plurality of lights do not need to be equal frequency intervals. For the sake of simplicity, in the following description, the light of the computational basis is at any position of equal frequency intervals, and the high-dimensional quantum state generated by equations (2) to (5) is expressed as a superposition of the states of the computational basis.

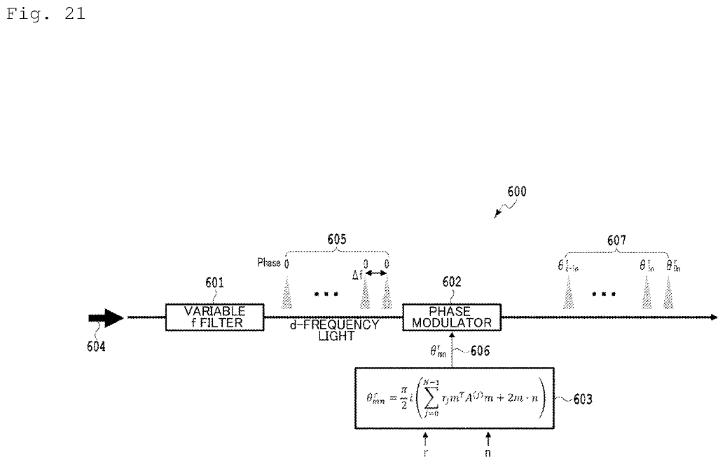

FIG. 21 is a diagram showing a configuration of a state generation device based on a frequency-bin quantum state of a MUB utilizing a finite field of the present disclosure. A state generation device 600 generates a state specified by equations (3) to (5) for MUBs utilizing a finite field of the order d=2^{N}. Compared with the time-bin quantum state generation device 30 shown in FIG. 4, the device is also common to the point that a phase modulator 602 is provided. A first difference from the state generation device of the time-bin quantum state shown in FIG. 4 is that the phase modulator 602 has the capability of independently modulating light of different frequencies instead of different times. A second difference is that a variable frequency filter 601 is provided instead of the intensity modulator 31 in FIG. 4 to generate the state of the computational basis of equation (5) in the frequency-bin quantum state.

Light 604 of a plurality of frequencies including at least all the frequencies of light of the computational basis is input to the state generation device 600. The variable frequency filter 601 or the phase modulator 602 can be controlled to output the input light 604 as continuous light, only for a predetermined time period. Further, the input light 604 may be input only for a predetermined time period corresponding to the frequency-bin state, and the variable frequency filter 601 and the phase modulator 602 may be operated in synchronization with the input light 604. A phase modulator 602 applies phase modulation different for each frequency to the input light 604 including d different frequencies, thereby obtaining a quantum state 607 of a predetermined MUB. The modulation signal generator 603 generates a modulation signal (control signal) 606 for applying the phase modulation according to the probability amplitude of equation (4) to the input light 605 including d different frequencies, based on the information r of the basis and the information of the label n of the state in the basis.

By the generation device 600 having the configuration of FIG. 21, the high-dimensional quantum state of the MUB utilizing the finite field having only four relative phases with respect to the light located at one end on the frequency axis in the d light having different frequencies can be generated. Even when the dimension d=2^{N} increases, since each light can take only four phases at most, the required conditions of phase resolution can be greatly relaxed as in the case of a time-bin quantum state.

In the state generation device 600 of FIG. 21, the variable frequency filter 601 is used to select only the light of one desired frequency in the input light 605 to generate the state of the computational basis. Here, if the phase modulator 602 also has an amplitude modulation function, the variable frequency filter 601 can be omitted. That is, the state generation device 600 can be realized only by an optical modulator capable of modulating the phase and amplitude of a plurality of lights having different frequencies independently for each frequency. In this case, the optical IQ modulator 41 of FIG. 5 in the time-bin quantum state may be replaced by an optical modulator capable of modulating the phase and amplitude independently for each frequency.

The above-mentioned optical modulator capable of modulating the phase and amplitude can be realized by a combination of spatial optical components and liquid crystal on silicon (LCOS) as disclosed in, for example, NPL 9. That is, the input light from the input fiber is separated in the x-direction by the diffraction grating, further input to the element constituting surface of the LCOS, and phase modulation is applied in the x-direction and returned to the output fiber, thereby applying the phase modulation for each frequency. The amplitude modulation can be realized, for example, by changing a coupling ratio between the modulated light and the output fiber by some means. In the MUB state generation device utilizing the frequency-bin state of the present disclosure, the method and the configuration of realizing the optical modulator are not limited as long as the phase and amplitude can be modulated independently for each frequency.

Even in the case of the state generation device of MUB utilizing a finite field of dimension d=p^{N} (p: odd prime), the above-mentioned configuration of the state generation device 600 can be applied in the same manner. Since the set phase to the phase modulator 602 is different, the modulation signal 606 to be applied from the modulation signal generator 603 is only different from the case of dimension d=2^{N}.

### Implementation of State Measurement Device By Frequency-bin State

The state measurement device of the MUB utilizing the finite field in the frequency-bin state can also be realized by replacing a part of the constituent elements of the configuration of the time-bin quantum state described in FIGS. 6 to 7. The variations of various configurations in the case of the time-bin quantum state shown in FIGS. 8 to 14 can also be similarly applied.

Similarly to the case described in the state measurement device of the time-bin quantum state, equation (4) representing the probability amplitude Bₘₙ^{(r)} of the MUB utilizing the finite field is also common to the state measurement device of the frequency-bin state. Therefore, Dₘₘ^{(r)} in equation (6) is a diagonal unitary matrix, and in the case of a frequency-bin quantum state, Dₘₘ^{(r)} corresponds to phase modulation to each of a plurality of lights having different frequencies. A first unit for performing an operation corresponding to a diagonal unitary matrix of the Dₘₘ^{(r)} of of equation (6) can be realized as a phase modulator for a computational basis of a frequency-bin state.

Further, the operation corresponding to Bₘₙ⁽⁰⁾ of equation (6) can be realized as a second unit for performing the projective measurement on the Hadamard transformed basis. The state measurement device of the MUBs in the frequency-bin state is configured to include a unit for performing phase modulation according to equation (7), on the front stage side of a measurement unit for operating the Hadamard transform matrix. By means of a unit corresponding to two matrices decomposed from the probability amplitude Bₘₙ^{(r)} of the MUB, a measurement to a basis (MUB of label r) having the probability amplitude Bₘₙ^{(r)} of equation (4) can be realized. Here, the operation of the Hadamard transform unit in the frequency-bin state will be described in comparison with the operation in the time-bin quantum state of FIG. 7.

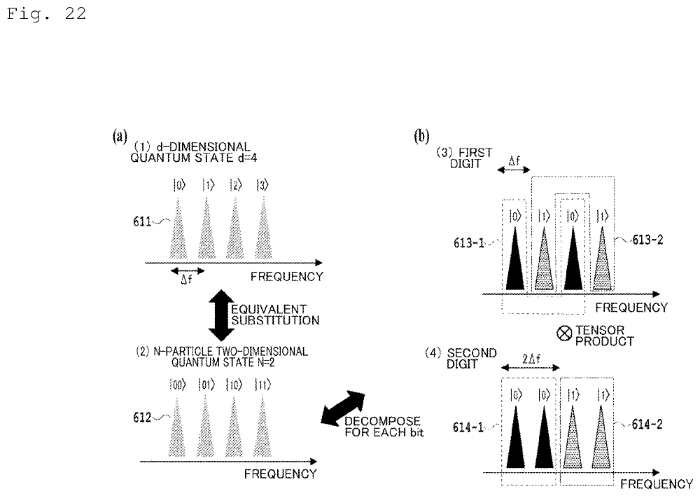

FIG. 22 is a diagram conceptually explaining the operation of the Hadamard transform unit in the frequency-bin quantum state. FIG. 22(a) explains the replacement of the frequency-bin quantum state from the d-dimensional quantum state to the equivalent state of a plurality of particles. The dimension d=4, that is, the four-dimensional quantum state 611 is considered. Each position of the light arranged on the frequency axis at a frequency interval Af corresponds to four quantum states |0>, |1>, |2>, |3> of the computational basis. Here, this four-dimensional quantum state is considered as an N-particle two-dimensional quantum state having an equivalent dimension. Similarly to the case of the time-bin quantum state, the four quantum states 611 can be replaced such as four quantum states 612 of |00>, |01>, |10> and |11>, as a bit string expression of 2 bits (N=2).

FIG. 22(b) explains an operation of decomposing the N-particle two-dimensional quantum state for each bit as the next stage. When the four quantum states 612 which are two-particle two-dimensional states are decomposed into two states for each digit by paying attention to bits of each digit, the four quantum states 612 are divided into two blocks having different frequency differences Δf. When attention is paid to the first digit of the quantum state 612, the block 613-1 of the state |0> and the block 613-2 of the state |1> are divided, and the frequency difference between the two blocks is Δf. When attention is paid to the second digit of the quantum state 612, the block 614-1 of the state |0> and the block 614-2 of the state |1> are divided, and the frequency difference between the two blocks is 2Δf. The transformation of Bₘₙ⁽⁰⁾ of the second unit in the frequency-bin quantum state is an operation performing two-dimensional Hadamard transform on a bit-by-bit decomposition of the N-particle two-dimensional quantum state equivalent to the quantum state of the measurement object shown in FIG. 22(b), that is, all the equivalent qubits. There is also no difference between the case of the time-bin quantum state and the case of frequency-bin quantum state. The difference from the time-bin quantum state is the configuration of an interference structure that realizes the superposed state of all the states of a plurality of lights having different frequencies.

Therefore, the Hadamard transform unit in the frequency-bin quantum state is realized with a configuration suitable for the frequency-bin quantum state, and a position (photon detection position) for outputting different interference states may be made to associate with the projective measurement to the corresponding superposed state. The configuration of the Hadamard transform unit can be casily realized by replacing a part of the configuration for the time-bin quantum state with a configuration adapted to the frequency-bin quantum state. In order to superpose a plurality of lights having different frequencies, a configuration for generating a time delay in the time-bin quantum state may be replaced by a configuration for generating a frequency shift. The configuration for generating different interfered states can be applied to the disposition variations of the interference structures in configuration examples 1 to 4 described in the time-bin quantum state as they are.

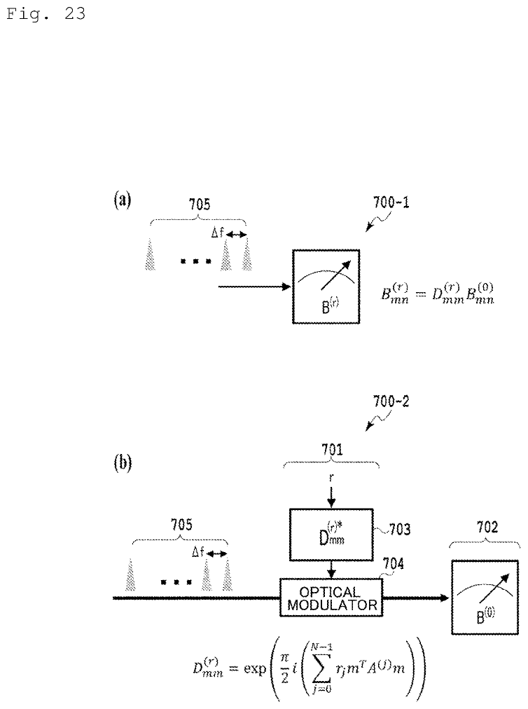

FIG. 23 is a diagram showing the configuration of the MUB state measurement device in the frequency-bin quantum state. A state measurement device 700-1 of FIG. 23(a) has the same configuration as the state measurement device 50-1 of the time-bin quantum state shown in FIG. 6(a), measures the probability amplitude Bₘₙ^{(r)} expressed by equation (4), and is different only in that the input light of the measurement object is light 705 arranged at the frequency interval Δf on the frequency axis. The quantum state measurement device 700-1 can be understood as a measurement device 50-1 for identifying a label n of a quantum state |ψₙ^{(r)}> having a probability amplitude Bₘₙ^{(r)} expressed by equation (4), for example, with respect to the input light 705 to be an object of the frequency-bin quantum state.

The state measurement device 700-2 of FIG. 23(b) shows a state measurement device 700-2 having a configuration in which the above-mentioned two units are combined. The measurement device 700-2 includes an optical modulation unit 701 corresponding to a first unit of the front stage side, which corresponds to a Dₘₘ^{(r)}, and a measurement unit 702 corresponding to a second unit, which corresponds to Bₘₙ⁽⁰⁾. The frequency-bin quantum state measurement device 700-2 is common to the time-bin quantum state measurement device shown in FIG. 6(b) in that it is made up of two units corresponding to the diagonal unitary matrix and the Hadamard transform matrix of equation (6).

The state measurement device 700-2 differs from the state measurement device 50-2 based on the time-bin quantum state shown in FIG. 6(b) in that the optical modulator 704 as the first unit 701 has the ability to modulate light of different frequencies independently. Therefore, as the optical modulator 704 of the state measurement device 700-2, it is possible to use the same thing as the phase modulator 602 in the state generation device 600 of the MUBs in the frequency-bin quantum state. The modulation signal generator 703 applies a modulated signal to the phase modulator 704. Similarly to the case of the time-bin quantum state, the optical modulation unit 704 needs not to transform from the 0th basis (label 0) to the r-th basis (label r) but to transform from the r-th basis to the Oth basis. Therefore, in the measurement device, the inverse transformation of the transformation expressed by equation (6), that is, the phase modulation which becomes the complex conjugate of the Dₘₘ^{(r)} of equation (6) is performed.

The measurement corresponding to the matrix Bₘₙ⁽⁰⁾ which is the second unit of the state measurement device 700-2 can be performed as a projective measurement to a state in which two-dimensional Hadamard transform is performed on equivalent lower-dimensional two-dimensional quantum states (qubits) which are decomposition of the frequency-bin quantum state as a measurement object.

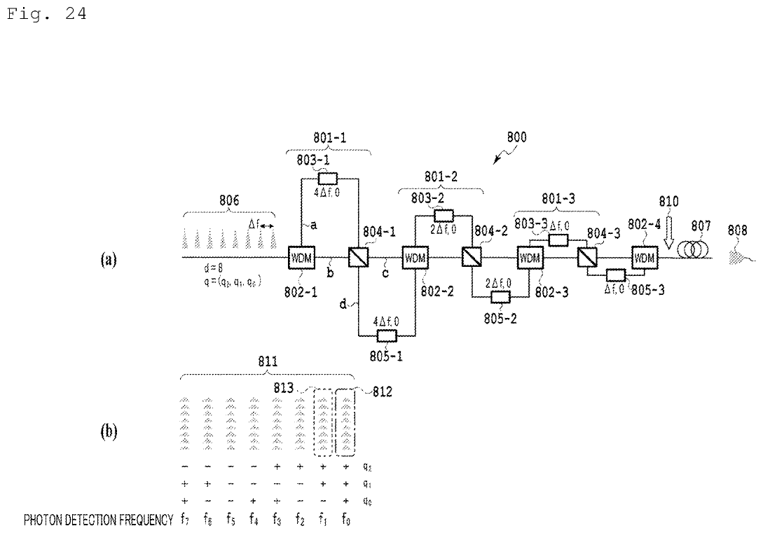

FIG. 24 is a diagram showing the configuration of the Hadamard transformed state measurement unit in the frequency-bin quantum state. A Hadamard transformed state measurement unit 800 of FIG. 24 corresponds to the Hadamard transformed state measurement unit 100 of configuration example 3 in the time-bin quantum state. The Hadamard transformed state measurement unit 800 is similar to the Hadamard transformed state measurement unit 100 of configuration example 3 in that three interference structures 801-1 to 801-3 are cascade-connected and are made up of a path for connecting the interference structures (layers) in parallel. However, in order to realize a superposed state of the plurality of lights for a plurality of lights 806 (d=8) having different frequencies of the frequency-bin quantum states of interest, a configuration described below that is different from the case of the time-bin quantum states is used. The “interference structure” described below corresponds to an interferometer (MZI) in a time-bin quantum state, and each of them includes an optical coupler, and interference can be generated by appropriately operating the split input light.

An interference structure 801-1 of the first layer includes a wavelength separation filter 802-1, two branch paths a and b, and an optical coupler 804-1, and one branch path a is provided with a frequency shifter 803-1. The wavelength separation filter 802-1 separates four lights on the low-frequency side into a branch path a, and separates four lights on the high-frequency side into a branch path b with respect to eight lights 806 of different frequencies disposed at a frequency interval Δf in a frequency-bin state. The frequency shifter 803-1 of the branch path a gives a frequency shift of 4Δf to the four lights on the low-frequency side. At this time, in the output of the optical coupler 804-1, a phase difference between a plurality of lights propagated through the branch path a and a plurality of lights propagated through the branch path b is set to 0.

Adjacent layers of the interference structure are connected by two paths having different frequency shift amounts. For example, the interference structure 801-1 of the first layer is connected to the interference structure 801-2 of the second layer by a branch path c and a branch path d connecting the layers. In the branch path d, a frequency shift of 4Δf equal to the frequency shift amount on the front layer side is given by a frequency shifter 805-1. Frequency shifts 2Δf and Δf which are each the same as those of the front layer side are given in one branch path, between the second layer and the third layer, and between the third layer and the wavelength separation filter 802-4 of the final stage. The Hadamard transformed state measurement unit 800 of FIG. 24(a) is depicted to understand the correspondence to the configuration of the time-bin quantum state of FIG. 11(a), the constituent clements, and their connections. It should be noted that the configuration including the branch paths in the three interference structures is depicted as if they were waveguides of different lengths, but there is no time delay difference between the two branch paths a and b. Similarly, there is no time delay difference in the branch paths C and d for connecting the two interference structures. As the above-mentioned wavelength separation filter, for example, a WDM filter can be used.

By the interference structure including the three layers of frequency-shift elements described above, in eight input lights with different frequencies, the path of the wavelength separation filter of each layer is determined in accordance with |0> and |1> of each qubit, when the eight states (dimension d=2³) of the computational basis is made to correspond to (associated with) equivalent three-particle two-dimensional quantum states (q₂, q₁, q₀). First, in the wavelength separation filter 802-1, eight input lights are separated so that lights of a frequencies corresponding to |0> of equivalent q₂ pass through the branch path a, and lights of the frequencies corresponding to |1> passes through the branch path b. The light passing through the upper branch path a is given the frequency shift of 4Δf relative to the branch path b by the frequency shifter 803-1.

The two sets of light separated into the two branch paths interfere with each other at a relative phase 0, using an optical coupler 804-1. As a result of the interference in the optical coupler 804-1, information on the measurement of |0>, |1> for the equivalent qubit, that is, q₂ is given by whether it is output to branch path c or branch path d of the coupler output gives.

The path separation, frequency shift, and interference are repeatedly performed in each interference structure of the second layer and the third layer as in the first layer, and at the final interferometer output point 810, it is possible to determine on which superposed state of the high-dimensional Hadamard transformed basis the lights are projected, depending on which frequency light the eight input lights 806 are observed as.

FIG. 24(b) is a diagram showing the correspondence between the frequency of the superimposed light observed at the interferometer output point 810 and the three-particle two-dimensional quantum state to be detected. In the same manner as in the case of configuration example 3 in the time-bin quantum state shown in FIG. 11(b), light 811 of an interfered state, which is a plurality of lights superposed on one frequency, is shown. The difference from the case of the time-bin quantum state is only in that whether the fact of photon observation is identified by the detection time (t₀, t₁, . . . t₇) of photon detection or by the detection frequency (f₀, f₁, . . . f₇). For example, when a photon is observed at a frequency fo in a superposed state of eight lights expressed by a dotted line region 812, it can be determined that the projective measurement to the |+,+,+> states is performed. Similarly, when a photon is observed at a frequency f₁ expressed by a dotted line region 813, it can be determined that the projective measurement to the |+,+,−> states is performed.

When the 8-dimensional quantum state is expressed by qubit in an equivalent 3-particle 2-dimensional quantum state, it can be determined to which state of the two-dimensional quantum states |+>, |−> on the equivalent qubit the projective measurement is performed as follows.
Photon detection at the frequency f₀->|+, +, +> state
Photon detection at the frequency f₁->|+, +,−> state
Photon detection at the frequency f₂->|+, −, −> state
Photon detection at the frequency f₃->|+, −, +> state
Photon detection at the frequency f₄->|+, −, +> state
Photon detection at the frequency f₅->|−, −, −> state
Photon detection at the frequency f₆->|−, +,−> state
Photon detection at the frequency f₇->|−, +, +> state

In the Hadamard transformed state measurement unit 800 of FIG. 24, it should be able to specify the frequency at which the photon is detected by the photon detector 808. In general, the photon detector has no frequency identification capability, but it is possible to measure the frequency detected by the photon by converting the frequency information into time information using, for example, a high dispersion fiber 807. Further, the frequency is identified using a wavelength separation filter at the interferometer output point 810, and the final projective measurement can be easily implemented by including a photon detector corresponding to each frequency.

Thus, the Hadamard transformed state measurement unit in the frequency-bin quantum state is implemented to include any one of a first configuration (corresponding to configuration example 1 of FIG. 8) including a plurality of optical interference structures which are disposed in a tree shape with N layers and each of which a frequency shift corresponding to the layer position of the N layers is given; a second configuration (corresponding to configuration examples 2 and 3 of FIGS. 10 and 11) including a plurality of optical interference structures which are cascade-connected to N layers and each of which a frequency shift corresponding to the layer position of the N layers is given, and one or more paths set with frequency shifts corresponding to the frequency shifts of the optical interference structures of previous layer in parallel to the connection between two adjacent layers; or a third configuration 800 (corresponding to configuration example 4 of FIG. 12) including an optical interference structure which is connected in a loop and each of which a variable frequency shift corresponding to the number of laps is given.

It will be understood that, in the above-described configuration of FIG. 24, the path separation, frequency shift and interference are repeated in the interference structure of each layer, thereby performing an operation for superposing a plurality of lights having different frequencies on one frequency. Then, the interference output from one interference structure is made to correspond to (associated with) |+>, |−> projective measurement for each qubit equivalent to the high-dimensional quantum state of the measurement object. Also in this respect, the operation of the Hadamard transformed state measurement unit is common between the time-bin quantum state and the frequency-bin quantum state. Further, the interference structure includes an element for separating the input light into two or more paths, an element for converting or shifting an orthogonal mode to the light of at least one path, and an element for multiplexing and interfering the separated light. The specific configuration of these elements may be adapted in accordance with the mode of light such as the time-bin quantum state or the frequency-bin quantum state, and is shown in Table 1 below.

TABLE 1
Comparison of elements of interference structure

| | Time-bin quantum | Frequency-bin |
|---|---|---|
| | state | quantum state |
| Input light is separated | Optical coupler, | WDM filter, optical |
| into two or more | optical SW | SW |
| Orthogonal mode | Delay waveguide and a | Frequency shifter |
| transform and shift | delay line | |
| Combining separated | Optical coupler, | Optical coupler, |
| light | optical SW | optical SW |

Formation of a tree structure (configuration example 1) using the above-mentioned interference structure in a plurality of layers, reuse of one interference structure (configuration example 2), connection to a cascade (configuration example 3), formation of a loop shape (configuration example 4) can be enabled in common regardless of the mode of light.

As described above, the MUB state measurement device using the frequency-bin quantum state can be realized as a first unit corresponding to the diagonal unitary matrix of the Bₘₙ^{(r)} of equation (6) and a second unit for performing projective measurement on the Hadamard transformed basis corresponding to the Bₘₙ⁽⁰⁾ of equation (6). It has common compositional features regardless of the mode of light, in that the probability amplitude of the quantum state of the measurement object is decomposed into diagonal unitary transform and high-dimensional Hadamard transform, and is decomposed and mounted in units of respective partial systems. An operation corresponding to diagonal unitary transform is implemented as a phase modulation of at most four values to the orthogonal mode of the light to be utilized when the dimension d is 2^{N}. The request of phase resolution of the related art can be relaxed.

The above discussion holds similarly for the case of dimension d=p^{N} (p: odd prime), and the probability amplitude Bₘₙ^{(r)} according to equation (13) can be expressed by the first unit corresponding to the diagonal unitary matrix of Dₘₘ^{(r)} and the second unit corresponding to the tensor product of the Fourier transform matrices of Bₘₙ⁽⁰⁾ of equation (14). It is apparent that the configuration of the multi-arm interferometer shown in FIGS. 19 and 20 can be applied to a frequency-bin quantum state as long as the time delay is replaced by a frequency shift. If the dimension d=p^{N}, it can be implemented as a phase modulation of a p-value at most with respect to the orthogonal mode of the light to be utilized, and the same effect is obtained for relaxing the requirement of the phase resolution of the related art.

It is needless to say that the features of the configuration of the state measurement device of the present disclosure can be applied to various high-dimensional quantum states utilizing other orbital angular momentum, optical path information, spatial modes in a multimode fiber, and the like.

### INDUSTRIAL APPLICABILITY

The present invention can be used for quantum information processing and quantum communication such as quantum key distribution and quantum state tomography.

1. A measurement device for performing projective measurements onto higher-dimensional quantum states which are defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1),
wherein d=2^{N} (N is a natural number of 2 or more),
the quantum state of the label n is expressed by the following equation,
$$\vert {ψ}_{n}^{( r )} 〉 = {\sum }_{m} {B}_{mn}^{( r )} \vert m 〉$$
wherein a probability amplitude Bₘₙ^{(r)} is decomposed into a diagonal unitary matrix and a Hadamard transform matrix, the measurement device comprises:
a phase modulation unit which corresponds to the diagonal unitary matrix, and applies a phase modulation to each of the state of the computational basis of a received d-dimensional quantum state; and
a measurement unit which corresponds to the Hadamard transform matrix and determines the label n of the d-dimensional quantum state.

2. The measurement device according to claim 1,
wherein an element serving as a basis of a finite field of an order d is defined as fᵢ, and a symmetry matrix A^{(j)} satisfies the following equation:
$${f}_{i} ⊙ {f}_{j} = {\sum }_{k = 0}^{N - 1} {A}_{ij}^{( k )} {f}_{k}$$
the probability amplitude is expressed by
$${B}_{mn}^{( r )} = \frac{1}{\sqrt{{2}^{N}}} exp ( \frac{π}{2} i ( {\sum }_{j = 0}^{N - 1} {r}_{j} {m}^{T} {A}^{〈 j )} m + 2 m \cdot n ) ) ,$$
and takes only four phase states, and
the state that constitutes the basis of r=0 is expressed by a tensor product of two states |+> and |−>, the two states |+> and |−> being for N-particle two-dimensional quantum states equivalent to the d-dimensional quantum state, and the measurement unit performs a projective measurement on the tensor product.

3. A measurement device for performing projective measurements onto higher-dimensional quantum states which are defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1),
wherein p is an odd prime, d-p^{N} (N is a natural number), and the quantum state of the label n is expressed by the following equation:
$$\vert {ψ}_{n}^{( r )} 〉 = {\sum }_{m} {B}_{mn}^{( r )} \vert m 〉$$
wherein a probability amplitude Bₘₙ^{(r)} is decomposed into a diagonal unitary matrix and a tensor product of the Fourier transform matrix,
the measurement device comprises:
a phase modulation unit which corresponds to the diagonal unitary matrix, and applies a phase modulation to each of the state of the computational basis of a received d-dimensional quantum state; and
a measurement unit which corresponds to the Fourier transform matrix and determines the label n of the d-dimensional quantum state.

4. The measurement device according to claim 3,
wherein an element as a basis of a finite field of order d is set as fᵢ, and the symmetric matrix A^{(j)} satisfies the following equation:
$${f}_{i} ⊙ {f}_{j} = {\sum }_{k = 0}^{N - 1} {A}_{ij}^{( k )} {f}_{k}$$
the probability amplitude is expressed by
$${B}_{mn}^{( r )} = \frac{1}{\sqrt{{2}^{N}}} exp ( \frac{2 π}{p} i ( {\sum }_{j = 0}^{N - 1} {r}_{j} {m}^{T} {A}^{〈 j )} m + m \cdot n ) ) ,$$
and takes only p phase states,
a state constituting a basis of r=0 is expressed by a tensor product of any N of p states |f₀>, |f₁>, . . . |fₚ₋₁>, the p states |f₀>, |f₁>, . . . |fₚ₋₁> being for N-particle p-dimensional quantum states equivalent to the d-dimensional quantum state, and the measurement unit performs the projective measurement onto the tensor product.

5. The measurement device according to claim 1,
wherein the state of the orthogonal light is one of
a time-bin quantum state which associates each pulse of d continuous pulse trains with a state of the computational basis, and utilizes orthogonal modes of time, or
a frequency-bin quantum state which associates light with different frequencies with each state of the computational basis, and utilizes orthogonal modes of frequency.

6. The measurement device according to claim 5,
wherein the state of the orthogonal light is a time-bin quantum state, and
the measurement unit includes one of
a first configuration including a plurality of optical interferometers which are disposed in a tree shape with N layers, each of the plurality of optical interferometers having a delay time corresponding to a layer position of the N layers,
a second configuration including
a plurality of optical interferometers which are cascade-connected to the N layers, each of the plurality of optical interferometers having a delay time corresponding to the layer position of the N layers, and
one or more delay lines in which delay times are set corresponding to the delay times of the optical interferometers of the previous layer in parallel with the connection between two adjacent layers, or
a third configuration including an optical interferometer which is connected in a loop, the optical interferometer having a variable delay time corresponding to the number of laps.

7. (canceled)

8. The measurement device according to claim 5,
wherein the state of the orthogonal light is a frequency-bin quantum state, and
the measurement unit includes one of
a first configuration including a plurality of optical interference structures which are disposed in a tree shape with N layers, each of the plurality of optical interference structures having a frequency shift corresponding to the layer position of the N layers;
a second configuration including
a plurality of optical interference structures which are cascade-connected to the N layers, each of the plurality of optical interference structures having a frequency shift corresponding to the layer position of the N layers, and
one or more paths set with frequency shifts corresponding to the frequency shifts of the optical interference structures of the previous layer in parallel to the connection between two adjacent layers; or
a third configuration including an optical interference structure which is connected in a loop, the optical interference structure having a variable frequency shift corresponding to number of laps.

9. A generation device of a high-dimensional quantum state which is defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1),
wherein d=2^{N} (N is a natural number of 2 or more), and the quantum state of the label n is represented by the following equation:
$$\vert {ψ}_{n}^{( r )} 〉 = {\sum }_{m} {B}_{mn}^{( r )} \vert m 〉$$
wherein an element serving as a basis of a finite field of an order d is defined as fᵢ, and a symmetry matrix A^{(j)} satisfies the following equation,
$${f}_{i} ⊙ {f}_{j} = {\sum }_{k = 0}^{N - 1} {A}_{ij}^{( k )} {f}_{k}$$
and the probability amplitude is expressed by
$${B}_{mn}^{( r )} = \frac{1}{\sqrt{{2}^{N}}} exp ( \frac{π}{2} i ( {\sum }_{j = 0}^{N - 1} {r}_{j} {m}^{T} {A}^{〈 j )} m + 2 m \cdot n ) ) ,$$
and takes only four phase states.

10. A generation device of a high-dimensional quantum state which is defined by a computational basis {|m>|m∈{0, 1, . . . , d−1}} of d-dimensional quantum states made up of states of orthogonal light, and mutually unbiased bases of label r (integer of 0 or more) that are non-orthogonal to the computational basis and define a quantum state of label n (0, 1, . . . , d−1),
wherein d=p^{N} (N is a natural number, and p is an odd prime), and the quantum state of the label n is represented by the following equation:
$$\vert {ψ}_{n}^{( r )} 〉 = {\sum }_{m} {B}_{mn}^{( r )} \vert m 〉$$
wherein an element serving as a basis of a finite field of an order d is defined as fᵢ, and a symmetry matrix A^{(j)} satisfies the following equation:
$${f}_{i} ⊙ {f}_{j} = {\sum }_{k = 0}^{N - 1} {A}_{ij}^{( k )} {f}_{k}$$
the probability amplitude is expressed by
$${B}_{mn}^{( r )} = \frac{1}{\sqrt{{2}^{N}}} exp ( \frac{2 π}{p} i ( {\sum }_{j = 0}^{N - 1} {r}_{j} {m}^{T} {A}^{〈 j )} m + m \cdot n ) ) ,$$
and takes only p phase states.

11. The generation device according to claim 9,
wherein the state of the orthogonal light is a time-bin quantum state which associates each pulse of d continuous pulse trains with a state of the computational basis, and utilizes orthogonal modes of time, and
the state generation device comprises:
an amplitude modulator which switches between a state of a single pulse, which is a quantum state belonging to the computational basis, and a state made up of d pulses, which is a quantum state belonging to a basis non-orthogonal to the computational basis; and
a phase modulator which applies a phase modulation to each pulse of the d continuous pulse trains, based on information r of the basis and information of the label n of the state in the basis.

12. The generation device according to claim 9,
wherein the state of the orthogonal light is a frequency-bin quantum state which associates d lights having different frequencies on a frequency axis with each state of the computational basis, and utilizes orthogonal modes of frequency, and
wherein the state generation device comprises:
a frequency selection filter which switches between a state of a single frequency that is a quantum state belonging to the computational basis and a state of d frequencies that is a quantum states belonging to a basis non-orthogonal to the computational basis; and
a phase modulator which applies a phase modulation to each of the d lights having different frequencies based on the information r of the basis and the information of the label n of the state in the basis.

13. The generation device according to claim 9,
wherein the state of the orthogonal light is a time-bin quantum state which associates each pulse of d continuous pulse trains with the state of the computational basis, and utilizes an orthogonal mode of time, and includes any one of
a first configuration including a plurality of optical interferometers which are disposed in an inverted tree form with N layers from an input side to an output side, each of the plurality of optical interferometers having a delay time corresponding to a layer position of the N layers,
a second configuration including a plurality of optical interferometers which is cascade-connected to N layers, each of the plurality of optical interferometers having a delay time corresponding to the layer position of the N layers, or
a third configuration including an optical interferometer which is connected in a loop, the optical interferometer having a variable delay time corresponding to the number of laps; and
a phase modulator which is connected to a last stage of any of the configurations, and applies a phase modulation to each of the pulses based on the information r of the basis and information of label n of the state in the basis.

14. The generation device according to claim 10,
wherein the state of the orthogonal light is a time-bin quantum state which associates each pulse of d continuous pulse trains with a state of the computational basis, and utilizes orthogonal modes of time, and
the state generation device comprises:
an amplitude modulator which switches between a state of a single pulse, which is a quantum state belonging to the computational basis, and a state made up of d pulses, which is a quantum state belonging to a basis non-orthogonal to the computational basis; and
a phase modulator which applies a phase modulation to each pulse of the d continuous pulse trains, based on information r of the basis and information of the label n of the state in the basis.

15. The generation device according to claim 10,
wherein the state of the orthogonal light is a frequency-bin quantum state which associates d lights having different frequencies on a frequency axis with each state of the computational basis, and utilizes orthogonal modes of frequency, and
wherein the state generation device comprises:
a frequency selection filter which switches between a state of a single frequency that is a quantum state belonging to the computational basis and a state of d frequencies that is a quantum states belonging to a basis non-orthogonal to the computational basis; and
a phase modulator which applies a phase modulation to each of the d lights having different frequencies based on the information r of the basis and the information of the label n of the state in the basis.

16. The generation device according to claim 10,
wherein the state of the orthogonal light is a time-bin quantum state which associates each pulse of d continuous pulse trains with the state of the computational basis, and utilizes an orthogonal mode of time, and includes any one of
a first configuration including a plurality of optical interferometers which are disposed in an inverted tree form with N layers from an input side to an output side, each of the plurality of optical interferometers having a delay time corresponding to a layer position of the N layers,
a second configuration including a plurality of optical interferometers which is cascade-connected to N layers, each of the plurality of optical interferometers having a delay time corresponding to the layer position of the N layers, or
a third configuration including an optical interferometer which is connected in a loop, the optical interferometer having a variable delay time corresponding to the number of laps; and
a phase modulator which is connected to the last stage of any of the configurations, and applies a phase modulation to each of the pulses based on the information r of the basis and information of label n of the state in the basis.

17. The measurement device according to claim 3,
wherein the state of the orthogonal light is one of
a time-bin quantum state which associates each pulse of d continuous pulse trains with a state of the computational basis, and utilizes orthogonal modes of time, or
a frequency-bin quantum state which associates light with different frequencies with each state of the computational basis, and utilizes orthogonal modes of frequency.

18. The measurement device according to claim 17,
wherein the state of the orthogonal light is a time-bin quantum state, and
the measurement unit includes one of
a first configuration including a plurality of optical interferometers which are disposed in a tree shape with N layers, each of the plurality of optical interferometers having a delay time corresponding to a layer position of the N layers,
a second configuration including
a plurality of optical interferometers which are cascade-connected to the N layers, each of the plurality of optical interferometers having a delay time corresponding to the layer position of the N layers, and
one or more delay lines in which delay times are set corresponding to the delay times of the optical interferometers of the previous layer in parallel with the connection between two adjacent layers, or
a third configuration including an optical interferometer which is connected in a loop, the optical interferometer having a variable delay time corresponding to the number of laps.

19. The measurement device according to claim 18,
wherein p is an odd prime and the dimension is d=pN, the optical interferometer includes a multi-arm interferometer including p arm waveguides of different lengths.

20. The measurement device according to claim 17,
wherein the state of the orthogonal light is a frequency-bin quantum state, and
the measurement unit includes one of
a first configuration including a plurality of optical interference structures which are disposed in a tree shape with N layers, each of the plurality of optical interference structures having a frequency shift corresponding to the layer position of the N layers;
a second configuration including
a plurality of optical interference structures which are cascade-connected to the N layers, each of the plurality of optical interference structures having a frequency shift corresponding to the layer position of the N layers, and
one or more paths set with frequency shifts corresponding to the frequency shifts of the optical interference structures of the previous layer in parallel to the connection between two adjacent layers; or
a third configuration including an optical interference structure which is connected in a loop, the optical interference structure having a variable frequency shift corresponding to number of laps.
